(19) United States
(12) Patent Application Publication
(10) Pub. No.: US 2014/0181378 A1
(43) Pub. Date: Jun. 26, 2014

(54) CONTROL DEVICE, CONTROL METHOD, AND PROGRAM

(71) Applicant: SONY CORPORATION, Tokyo (JP)

(72) Inventors: Shusuke SAEKI, Tokyo (JP); Kenji FUDONO, Kanagawa (JP); Nobuhiro KANEKO, Kanagawa (JP); Kazumi SATO, Kanagawa (JP)

(73) Assignee: SONY CORPORATION, Tokyo (JP)

(21) Appl. No.: 14/105,421

(22) Filed: Dec. 13, 2013

(30) Foreign Application Priority Data
Dec. 26, 2012 (JP) 2012-282613

(51) Int. Cl. G06F 12/02

(52) U.S. Cl. CPC G06F 12/0246
USPC 711/103

(57) ABSTRACT

There is provided a control device including, a reading and writing control unit configured to control writing and reading of data on and from a non-volatile memory that has a plurality of blocks each set to be a unit for performing erasure of data. The non-volatile memory stores order information indicating an order of the blocks in which data is to be written. The reading and writing control unit selects a writing target block that is a target block for writing of data according to the order indicated by the order information, and writes data in the selected writing target block.

### CROSS REFERENCE TO RELATED APPLICATIONS

This application claims the benefit of Japanese Priority Patent Application JP 2012-282613 filed Dec. 26, 2012, the entire contents of which are incorporated herein by reference.

### BACKGROUND

The present technology relates to a control device, a control method, and a program, and particularly to a control device, a control method, and a program that can shorten an activation time taken until writing and reading of data on and from a non-volatile memory, for example, a NAND flash memory can be performed.

In a NAND flash memory, for example, writing, reading, and erasing are electrically operated.

In such a NAND flash memory, writing is an operation of unidirectionally changing bits from “1” to “0,” and for this reason, it is necessary to perform erasure by changing the bits into “1” and then to write data thereon.

In addition, in such a NAND flash memory, writing and reading of data are performed in units of memory areas that are called pages, and erasure is performed in units of memory areas that are called blocks. Here, a block includes a plurality of pages.

However, it is inconvenient to control erasure in units of blocks and writing and reading of data in units of pages in a file system (and even in an application) that uses a NAND flash memory.

Thus, mounting a library (layer) that controls writing and reading of data on and from a NAND flash memory by performing logical-physical conversion in which one or more pages of each block are set as TU (Translation Unit) and logical addresses are converted into physical addresses in units of TUs has been proposed (for example, refer to Japanese Patent Application No. 4535117 and Japanese Unexamined Patent Application Publication No. 2012-13655).

### SUMMARY

In a library that controls writing and reading of data on and from a non-volatile memory such as a NAND flash memory, information is read from the non-volatile memory when it is activated, and based on the information, a logical-physical conversion table used in logical-physical conversion is created.

However, depending on a state of data writing on a non-volatile memory, there are cases in which it takes time to read such information used in creating the logical-physical conversion table from the non-volatile memory. In this case, an activation time taken until writing and reading of data on and from the non-volatile memory are possible is lengthened.

It is desirable to enable the activation time taken until writing and reading of data on and from a non-volatile memory can be performed to be shortened.

According to an embodiment of the present disclosure, there is provided a control device which includes a reading and writing control unit configured to control writing and reading of data on and from a non-volatile memory that has a plurality of blocks each set to be a unit for performing erasure of data, in which the non-volatile memory stores order information indicating an order of the blocks in which data is to be written, and the reading and writing control unit selects a writing target block that is a target block for writing of data according to the order indicated by the order information and writes data therein, and a program that causes a computer to function as the control device.

According to an embodiment of the present disclosure, there is provided a control method performed by a reading and writing control unit of a control device including the reading and writing control unit configured to control reading and writing of data on and from a non-volatile memory that has a plurality of blocks each set to be a unit for performing erasure of data, the non-volatile memory storing order information indicating an order of the blocks in which data is to be written, the method including selecting a writing target block that is a target block for writing of data according to the order indicated by the order information and writing data.

According to the control device, the control method, and the program according to the embodiments of the present technology, writing and reading of data on and from a non-volatile memory that has a plurality of blocks are performed by setting each of the blocks to be a unit for performing erasure of data. In other words, the non-volatile memory stores order information indicating an order of the blocks in which data is to be written, a writing target block that is a target block for writing of data is selected according to the order indicated by the order information, and then data is written therein.

According to an embodiment of the present disclosure, there is provided a control device including a reading and writing control unit configured to control writing and reading of data on and from a non-volatile memory that has a plurality of blocks each set to be a unit for performing erasure of data, and an allotment unit configured to allot a logical Translation Unit (TU) to a physical TU. Each of the blocks has a plurality of pages each set to be a unit for performing writing and reading of data. By setting a unit for performing logical-physical conversion in which a logical memory area is converted into a physical memory area to be a TU, the non-volatile memory stores logical TU numbers specifying logical TUs which are logical TUs allotted to physical TUs, in the physical TUs which are physical TUs each of which includes one or more of the pages. A predetermined physical TU among the physical TUs included in the block stores all of the logical TU numbers of the logical TUs each allotted to the physical TUs included in the block when the logical TUs are allotted to all of the physical TUs included in the block. When the number of blocks in which writing of data is completed is not equal to or higher than a threshold value decided in advance, the allotment unit allots the logical TUs to all physical TUs to which the logical TUs are not allotted among physical TUs included in a block of interest to be noted selected from the blocks that include writing-unperformed physical TUs, and the reading and writing control unit writes all of the logical TU numbers of the logical TUs each allotted to the physical TUs included in the block of interest, in the predetermined physical TU included in the block of interest.

In the control device according to the embodiment of the present technology described above, writing and reading of data on and from the non-volatile memory that has the plurality of blocks are controlled by setting each of the blocks to be a unit for performing erasure of data, and a logical TU (Translation Unit) is allotted to a physical TU. Here, each of the blocks has the plurality of pages each set to be a unit for performing writing and reading of data, and by setting a unit for performing logical-physical conversion in which a logical memory area is converted into a physical memory area to be a TU, the non-volatile memory stores logical TU numbers specifying logical TUs which are logical TUs allotted to physical TUs in the physical TUs which are physical TUs, each of which includes one or more of the pages. In addition, a predetermined physical TU among the physical TUs included in the block stores all of the logical TU numbers of the logical TUs each allotted to the physical TUs included in the block when the logical TUs are allotted to all of the physical TUs included in the block. In such a case, when the number of blocks in which writing of data is completed is not equal to or higher than the threshold value decided in advance, the logical TUs are allotted to all physical TUs among the physical TUs included in a block of interest to be noted selected from the blocks that include the writing-unperformed physical TUs to which the logical TUs are not allotted, and all of the logical TU numbers of the logical TUs each allotted to the physical TUs included in the block of interest are written in the predetermined physical TU included in the block of interest.

Note that the control device may be an independent device, or may be an internal block constituting one device.

In addition, the program can be provided by being transferred via a transfer medium or being recorded on a recording medium.

According to an embodiment of the present technology, it is possible to shorten an activation time taken until writing and reading of data on and from a non-volatile memory can be performed.

### BRIEF DESCRIPTION OF THE DRAWINGS

FIG. 1 is a block diagram illustrating a configuration example of hardware of a TV according to an embodiment to which the present technology is applied;

FIG. 2 is a block diagram illustrating a configuration example of an access control unit of which a function is realized by a CPU 12 executing a program;

FIG. 3 is a diagram for describing a configuration example of a flash memory 16;

FIG. 4 is a diagram for describing a TU;

FIG. 5 is a diagram for describing a logical-physical conversion table and a state map;

FIG. 6 is a diagram for describing reading of data from the flash memory 16;

FIG. 7 is a diagram for describing writing of data on the flash memory 16;

FIG. 8 is a diagram for describing a fold process of the flash memory 16;

FIG. 9 is a flowchart for describing an example of a table and map creation process by a logical-physical conversion library 22;

FIG. 10 is a diagram for describing an example of writing logical TU numbers on physical TUs;

FIG. 11 is a diagram for describing a reading pattern of reading of management information from a block when an all-number-writing method is adopted;

FIG. 12 is a flowchart for describing a management information reading process performed in the table and map creation process when the all-number-writing scheme is employed;

FIG. 13 is a diagram illustrating an example of a state of the flash memory 16 after formatting;

FIG. 14 is a diagram illustrating an example of a state in which data is written in a few physical TUs after the flash memory 16 is formatted;

FIG. 15 is a diagram for describing writing of data on the flash memory 16;

FIG. 16 is a diagram illustrating an example of a state in which, after the flash memory 16 is formatted, writing of data progresses and then some blocks turn into writing-completed blocks;

FIG. 17 is a diagram for describing reading of the management information during a table-map creation process in a state immediately after formatting of the flash memory 16 and a steady state;

FIG. 18 is a diagram illustrating an example of a state of the flash memory 16 mounted in a TV when it is released from a factory;

FIG. 19 is a block diagram illustrating a functional configuration example of the logical-physical conversion library 22;

FIG. 20 is a diagram illustrating an example of a stage of the flash memory 16 when a writing mode is a post-format mode;

FIG. 21 is a diagram illustrating an example of a state of the flash memory 16 when the writing mode is shifted to a normal mode from the post-format mode;

FIG. 22 is a flowchart for describing an example of a writing process of data on the flash memory 16 in the normal mode;

FIG. 23 is a flowchart for describing an example of a writing process of data on the flash memory 16 in the post-format mode;

FIG. 24 is a flowchart for describing an example of the table and map creation process by the logical-physical conversion library 22;

FIG. 25 is a flowchart for describing an example of a reading process of management information in the post-format mode;

FIG. 26 is a block diagram illustrating another functional configuration example of the logical-physical conversion library 22;

FIG. 27 is a diagram for describing a post-formatting process;

FIG. 28 is a diagram for describing an example of a timing at which post-formatting process is performed;

FIG. 29 is a diagram illustrating an example of a state of the flash memory 16 after the post-formatting process;

FIG. 30 is a flowchart for describing an example of the post-formatting process performed by the logical-physical conversion library 22;

FIG. 31 is a block diagram illustrating a configuration example of hardware of an embodiment of a memory card to which the present technology is applied; and

FIG. 32 is a block diagram illustrating a configuration example of another access control unit of which a function is realized by a CPU 101 executing a program.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### An Embodiment of a TV to Which the Present Technology is Applied>

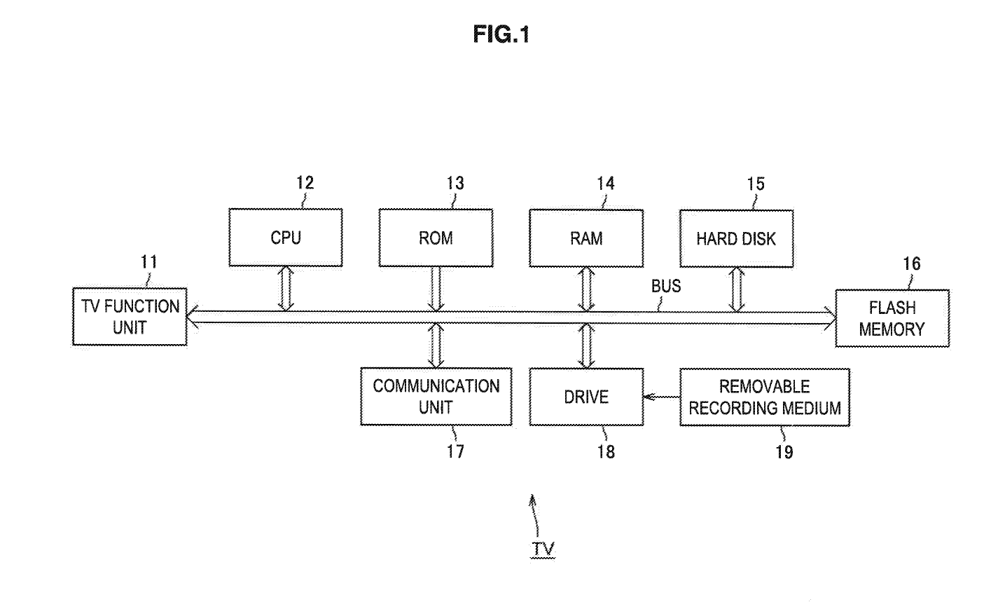

FIG. 1 is a block diagram illustrating a configuration example of hardware of a TV according to an embodiment to which the present technology is applied.

In FIG. 1, the TV is configured to include a TV function unit 11, a CPU (Central Processing Unit) 12, a ROM (Read Only Memory) 13, a RAM (Random Access Memory) 14, a hard disk 15, a flash memory 16, a communication unit 17, and a drive 18 which are connected to one another via a bus.

The TV function unit 11 has a tuner, a display, a speaker, and the like, which handle the primary functions of the TV.

The CPU 12 performs control of each block constituting the TV and various processes by loading programs stored in the ROM 13, the hard disk 15, and the flash memory 16 on the RAM 14 and executing them.

The ROM 13 stores programs executed by the CPU 12 and necessary data. The RAM 14 temporarily stores programs executed by the CPU 12 and necessary data. On the hard disk 15, programs executed by the CPU 12, necessary data, data of programs received by the TV function unit 11, and the like are recorded.

The flash memory 16 is, for example, a NAND flash memory, and stores data, and the like that need to be retained when the TV is turned off

The communication unit 17 controls communication between, for example, a network such as the Internet.

The drive 18 is designed to enable a removable recording medium 19, for example, a flexible disk, a CD-ROM (Compact Disc Read Only Memory), an MO (Magneto Optical) disc, a DVD (Digital Versatile Disc), a magnetic disk, a memory card, and the like to be loaded thereon or unloaded therefrom. The drive 18 drives the removable recording medium 19 loaded thereon, and then performs reading-writing (reading or writing, or both of them) of data (including programs) for the removable recording medium 19.

Note that programs that the CPU 12 executes can be installed in the ROM 13, the hard disk 15, and the flash memory 16 in advance.

In addition, the programs can be stored (recorded) in the removable recording medium 19, and then can be installed in the TV by loading the removable recording medium 19 on the drive 18. The removable recording medium 19 can be provided as so-called package software.

In addition, the programs can be downloaded on the TV through a communication network or a broadcasting network and then installed in the built-in hard disk 15. In other words, the programs can be transferred to the TV in a wireless manner through a satellite for digital satellite broadcasting from a download site, or can be transferred to the TV in a wired manner through a network such as a LAN (Local Area Network) or the Internet.

In the TV configured as described above, the CPU 12 (partially) functions as an access control unit that controls access to the flash memory 16 by executing an OS (Operating System) and other programs installed in the hard disk 15, and the like.

### <Configuration Example of the Access Control Unit>

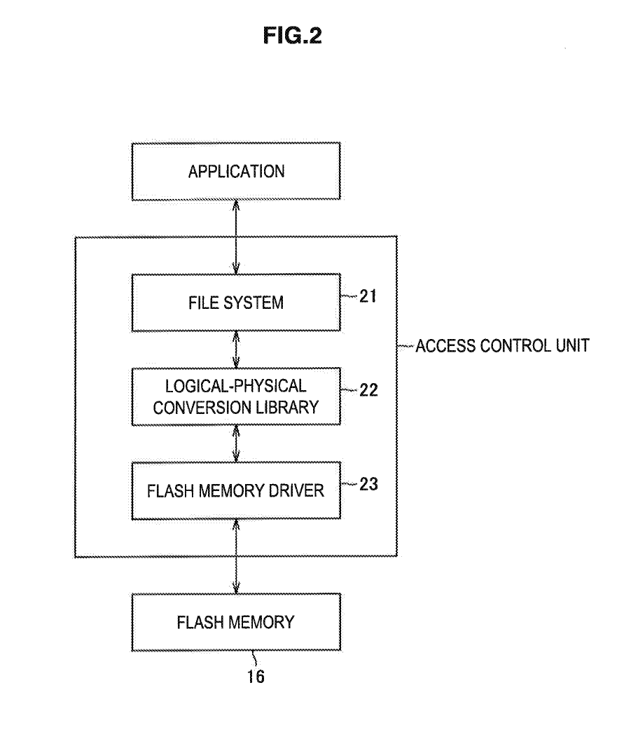

FIG. 2 is a block diagram illustrating a configuration example of the access control unit of which a function is realized by the CPU 12 of FIG. 1 executing a program.

The access control unit is a unit that provides the function of controlling access to the flash memory 16 among functions that the CPU 12 of FIG. 1 provides by executing the programs, and is configured to include a file system 21, a logical-physical conversion library 22, and a flash memory driver 23 that are software.

The file system 21 has a function of providing data on a device (the flash memory 16 in this case) as a file to applications.

In addition, the file system 21 designates logical TU numbers for specifying logical TUs to be described later, and makes a request for reading-writing of data from and on the logical TUs to the logical-physical conversion library 22.

The logical-physical conversion library 22 performs a process of logical-physical conversion for converting the logical TUs into physical TUs included in the flash memory 16 to be described later, and other process for reading-writing data from and on the physical TUs.

The logical-physical conversion library 22 converts the logical TU numbers into physical TU numbers for specifying the physical TUs according to the request received from the file system 21 for reading-writing of data to which the logical TU numbers are designated, and makes a request for reading-writing of data from and on the physical TUs of the physical TU numbers to the flash memory driver 23.

The flash memory driver 23 performs reading-writing of data on and from the physical TUs of the flash memory 16 according to the request from the logical-physical conversion library 22 for reading and writing of data.

### <Overview of the Flash Memory 16>

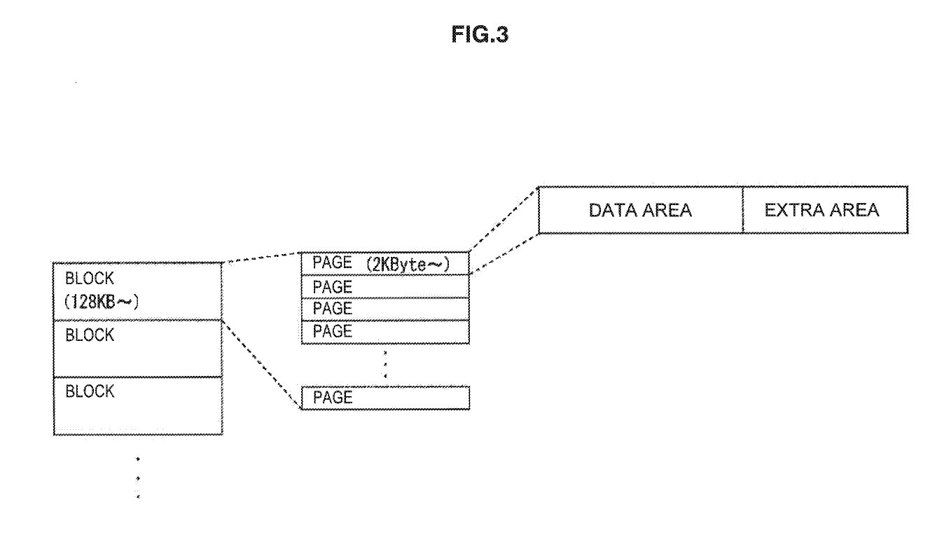

FIG. 3 is a diagram for describing a configuration example of the flash memory 16 of FIG. 1

The flash memory 16 (particularly, the memory area) includes a plurality, for example, thousands, of blocks, and each block includes a plurality of pages.

A page is a (minimum) unit for performing reading-writing of data on and from the flash memory 16, and a block is a unit for performing erasure.

Therefore, in the flash memory 16, the unit for performing erasure (block) is greater than the unit for performing reading and writing of data (page).

A page has a data region and an extended region. In the data region, data (actual data) is written, and in the extended region, auxiliary information is written.

Note that block numbers (for example, sequential numbers) for specifying blocks are given to each of the blocks. Likewise, page numbers (for example, sequential numbers) for specifying pages are also given to each of the pages constituting the blocks.

In the flash memory 16, writing of data on a page in a block should be performed in, for example, ascending order of the page numbers. Thus, writing of data on a page P included in a block B can be performed only when data is not written on the next pages to the page P (the pages having higher page numbers) of the block B. In other words, writing of data on the block B can be performed only on pages next to a page having the highest page number among pages of the block B on which data has been written.

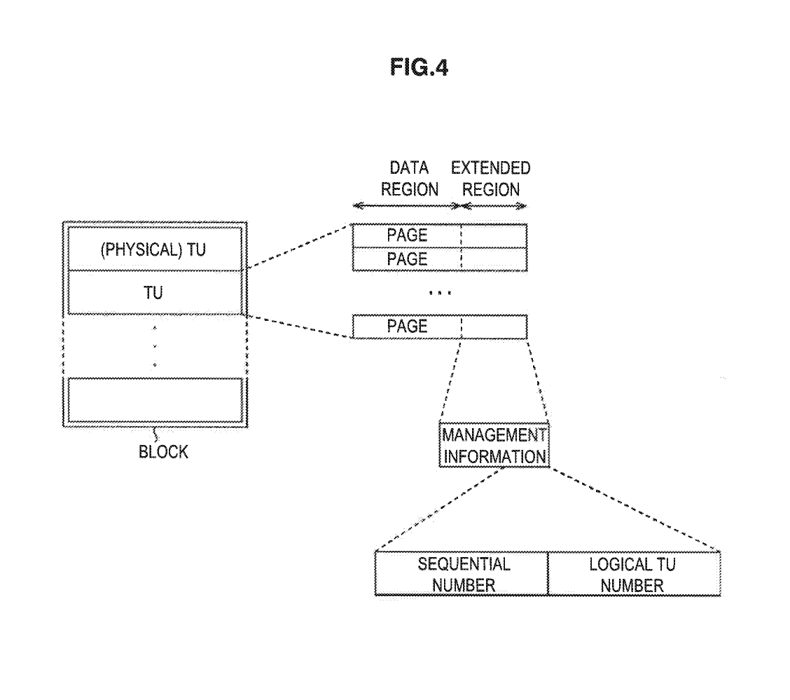

FIG. 4 is a diagram for describing a TU (Translation Unit).

A TU is a unit for performing logical-physical conversion in which a logical memory area is converted into a physical memory area, and the logical-physical conversion library 22 (of FIG. 2) performs logical-physical conversion, thereby providing access to the flash memory 16 in units of TUs to the file system 21.

In other words, the logical-physical conversion library 22 enables the file system 21 to access the flash memory 16 in units of logical TUs by performing logical-physical conversion for converting the logical TUs into the physical TUs.

Thus, the logical ills are virtual memory areas as judged by the file system 21 (or by external units) rather than a memory area (address space) that physically exists. The file system 21 controls (manages) (access to) the logical TUs that are virtual memory areas judged by the file system 21, independently of the logical-physical conversion library 22.

A physical TU includes one or more pages among pages constituting a block. A physical TU is as large as an integral reciprocal of the size of a block, and an integral multiple of the size of a page, and therefore, a block includes one or more physical TUs of which the number is equal to or lower than the number of pages constituting the block.

A physical TU has the same configuration as pages constituting the physical TU. In other words, a physical TU has a data region and an extended region as the page described in FIG. 3.

The data region of a physical TU corresponds to the data region of a page. In the data region of a physical TU, data (actual data) is written.

The extended region of a physical TU corresponds to the extended region of a page. In the extended region of a physical TU, management information for managing access to the physical TU is written (stored).

The management information includes sequential numbers and logical TU numbers.

A sequential number included in the management information is a number allotted to a block that has the physical TU in which the management information is written, indicating an order (ranking) in which data is written in the block. Thus, by referring to sequential numbers of each block, an order of blocks in which data is written can be recognized.

Here, a block with a higher sequential number is assumed to be a block on which data was written more recently.

A logical TU number included in the management information is a logical TU number of a logical TU allotted to a physical TU on which the management information is written.

It is set that a physical TU is constituted by one or more pages having consecutive numbers, and physical TU numbers (addresses, or for example, sequential numbers) for specifying physical TUs are given to the physical TUs.

In addition, a lower physical TU number is given to a physical TU including pages having lower page numbers.

In this case, when writing of data on pages in a block should be performed in ascending order of page numbers as described above, writing of data on physical TUs in the block should also be performed in ascending order of the physical TU numbers.

In addition, the management information can be written on, for example, the last page (a page having the highest page number) among pages constituting a physical TU.

### <Logical-Physical Conversion Table and State Map>

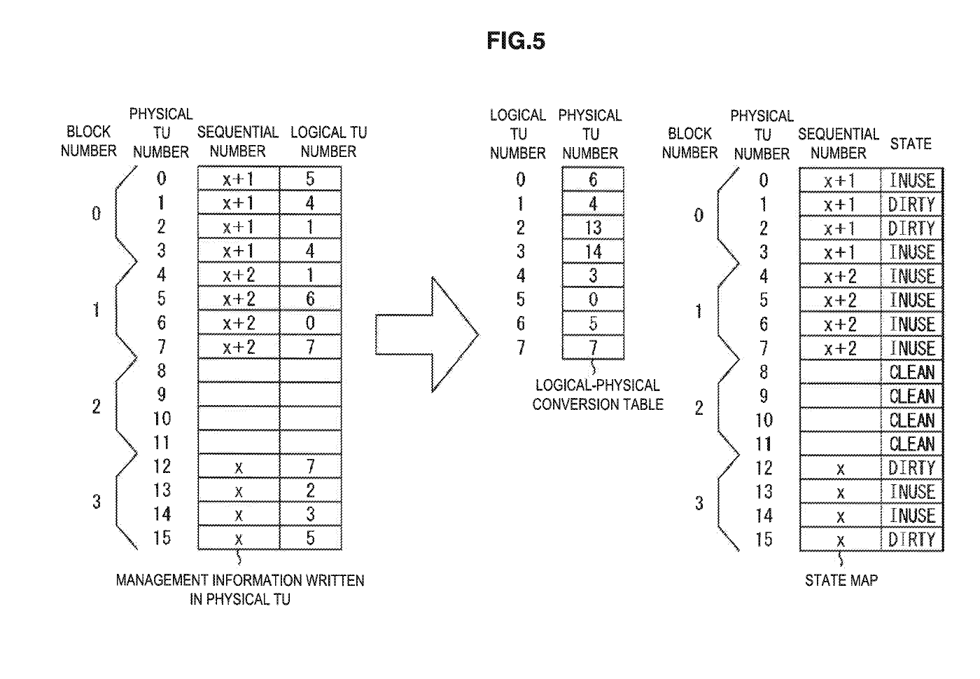

FIG. 5 is a diagram for describing a logical-physical conversion table and a state map.

The logical-physical conversion library 22 (of FIG. 2) creates a logical-physical conversion table and a state map based on management information written (stored) in physical TUs of the flash memory 16 when activated (immediately after the logical-physical conversion library 22 as software is executed by the CPU 12).

Then the logical-physical conversion library 22 performs reading and writing of data from and on the flash memory 16 referring to the logical-physical conversion table and the state map. Thus, the flash memory 16 is in a state of reading and writing data therefrom and thereon after creation of the logical-physical conversion table and the state map.

The logical-physical conversion table is a table for obtaining a physical TU to which a logical TU is allotted. In the logical-physical conversion table, logical TU numbers of logical TUs are registered in association with physical TU numbers to which the logical TU numbers are allotted.

The state map is a map for managing a state of each physical TU of the flash memory 16. In the state map, states of physical TUs of the flash memory 16 and sequential numbers allotted to a block that includes the physical TUs are registered.

Here, as the states of the physical TUs, there are four states of CLEAN, INUSE, DIRTY, and DEFECT.

CLEAN indicates a writing-unperformed state in which data (including the management information) is not yet written after erasure of the block that includes the physical TUs is performed, and INUSE indicates a state in which valid data to be read referring to the logical-physical conversion table is written (stored).

DIRTY indicates a state in which invalid data that has not been read is written referring to the logical-physical conversion table, and DEFECT indicates a state in which there is a defect in the block that includes the physical TU.

For the sake of simplifying the description, hereinafter, DEFECT among the four states of CLEAN, INUSE, DIRTY, and DEFECT of a physical TU will not be considered.

The logical-physical conversion library 22 writes the management information on the physical TUs together with data when writing the data on the physical TUs of the flash memory 16.

The management information written in the physical TUs includes sequential numbers indicating the order in which data is written in the block that has the physical TUs in which the management information is written and logical TU numbers of logical TUs allotted to the physical TUs in which the management information is written as described in FIG. 4.

In FIG. 5, the flash memory 16 has four blocks, and each block includes four physical TUs.

In other words, when a block having a block number i is also indicated by a block #1, and a physical TU having a physical TU number i is also indicated by a physical TU #i, the flash memory 16 has blocks #0, #1, #2, and #3 and a block #i is constituted by physical TUs #4i, #4i+1, #4i+2, and #4i+3 in FIG. 5.

In addition, in each physical TU of the blocks #0, #1, #2, and #3, the management information is written, and in each physical TU of the block #2, the management information is not written. Thus, the blocks #0, #1, and #3 are writing-completed blocks in which writing has been performed after erasure, and the block #2 is a writing-unperformed block in which writing has not been performed after erasure.

In each of physical TUs #0 to #3 constituting the writing-completed block #0, x+1 is written as a sequential number, and in each of physical TUs #4 to #7 constituting the writing-completed block #1, x+2 is written as a sequential number. In addition, in each of physical TUs #12 to #15 constituting the writing-completed. block #3, x is written as a sequential number.

Based on the sequential numbers described above, it can be recognized that the order in which writing is performed in the writing-completed blocks #0, #1, and #3 is the order of the blocks #3, #0 and #1.

In addition, in FIG. 5, in the physical TUs #0 to #3 constituting the writing-completed block #0, 5, 4, 1, and 4 are written as logical TU numbers, and in the physical TUs #4 to #7 constituting the writing-completed block #1, 1, 6, 0, and 7 are written as logical TU numbers. Further, in the physical TUs #12 to #15 constituting the writing-completed block #3, 7, 2, 3, and 5 are written as logical TU numbers.

Here, if it is set that a logical TU having a logical TU number i is also indicated by a logical TU #1, a logical TU #0, for example, is allotted only to the physical TU #6 in the management information of FIG. 5.

In this case, (0 that is the logical TU number of) the logical TU #0 is registered in association with (6 that is the physical TU number of) the physical TU #6 in the logical-physical conversion table as illustrated in FIG. 5.

Further, in the state map, INUSE indicating that valid data is written is registered as a state of the physical TU #6, and x+2 that is a sequential number of the block #1 that includes the physical TU #6 is registered as the sequential number of the physical TU #6.

In addition, in the management information of FIG. 5, for example, logical TU #4 is allocated to plural (two) units of the physical TUs #1 and #3.

The physical TUs #1 and #3 to which a logical TU #4 is allotted are included in the same block #0, however, in physical TUs included in a block, writing is performed in ascending order of the physical TU numbers. According to the writing rule, it can be recognized that, after writing of data that is expected to be written in the logical TU #4 (when judged by the file system 21) is performed in the physical TU #1, writing (rewriting) of data that is expected to be written in the logical TU #4 (when judged by the file system 21) is performed in the physical TU #3.

Thus, it can be recognized that invalid data that is old data written in the logical TU #4 is written in the physical TU #1, and valid data that is the latest data written in the logical TU #4 is written in the physical TU #3.

As a result, the physical TU #3 in which the valid data is written is registered in association with the logical TU #4 in the logical-physical conversion table as illustrated in FIG. 5.

Further, in the state map, DIRTY indicating that invalid data is written is registered as a state of the physical TU #1, and INUSE indicating that valid data is written is registered as a state of the physical TU #3.

In addition, in the state map, as a sequential number of the physical TUs #1 and #3, x+1 that is the sequential number of the block #0 that includes the physical TUs #1 and #3 is registered.

In the management information of FIG. 5, a logical TU #7, for example, is allotted to plural (two) units of the physical TUs #7 and #12.

The physical TUs #7 and #12 to which the logical TU #7 is allotted are respectively included in the blocks #1 and #3, however, since the sequential number of the physical TU #7 is x+2, and the sequential number of the physical TU #12 is x, it is recognized that writing of data that is expected to be written in the logical TU is performed in the physical TU #12, and then writing (rewriting) of data that is expected to be written in the logical TU #7 is performed in the physical TU #7.

Thus, it can be recognized that invalid data that is old data written in the logical TU #7 is written in the physical TU #12, and valid data that is the latest data written in the logical TU #7 is written in the physical TU #7.

As a result, the physical TU #7 in which the valid data is written is registered in association with the logical TU #7 in the logical-physical conversion table as illustrated in FIG. 5.

Further, in the state map, INUSE indicating that valid data is written is registered as a state of the physical TU #7, and DIRTY indicating that invalid data is written is registered as a state of the physical TU #12.

In addition, in the state map, x+2 that is a sequential number of the block #1 that includes the physical TU #7 is registered as the sequential number of the physical TU #7. As the sequential number of the physical TU #12, x that is the sequential number of the block #3 that includes the physical TU #12 is registered.

Hereinafter, the logical-physical conversion library 22 (of FIG. 2) creates the logical-physical conversion table and the state map (registers information on the logical-physical conversion table and the state map) based on the management information written in the physical TUs of the flash memory 16.

Note that, in FIG. 5, CLEAN indicating that writing is not performed is registered for the physical TUs #8 to #11 in which the management information is not written in the state map.

In addition, the logical-physical conversion table and the state map are stored, for example, in the RAM 14 (of FIG. 1).

### <Reading of Data From the Flash Memory 16>

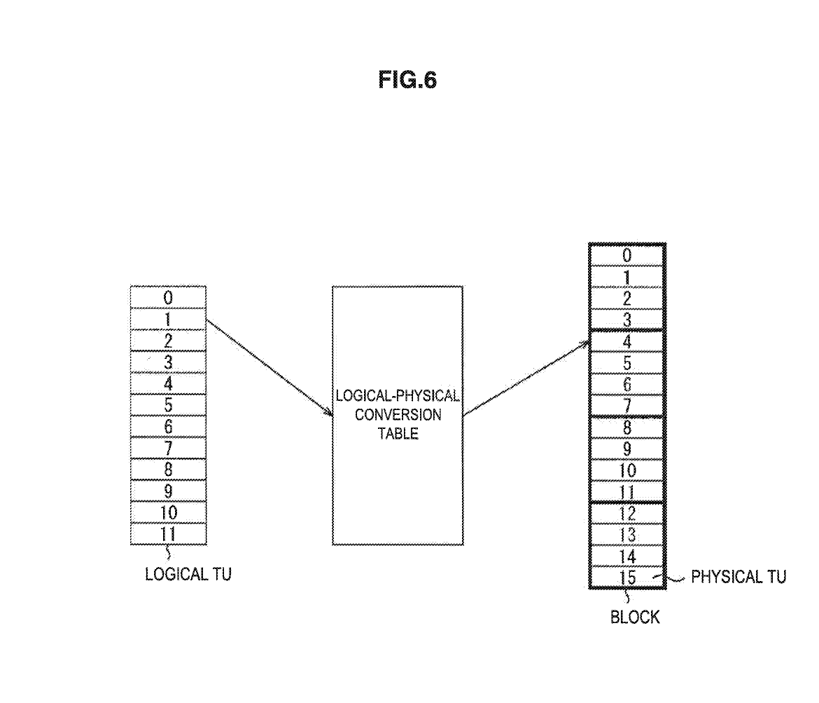

FIG. 6 is a diagram for describing reading of data from the flash memory 16. When there is a request for reading data for which logical TU numbers are designated from the file system 21, the logical-physical conversion library 22 (of FIG. 2) converts the logical TUs (or their numbers) from the file system 21 into physical TUs (or their the numbers) to which the logical TUs are allotted, referring to the logical-physical conversion table, and then makes a request for reading data from the physical TUs to the flash memory driver 23.

In FIG. 6, a request for reading data from the logical TU #1 is made from the file system 21. Then, it is recognized that the logical TU #1 is allotted to the physical TU #4 with reference to the logical-physical conversion table, and data is read from the physical TU #4.

### <Writing of Data on the Flash Memory 16>

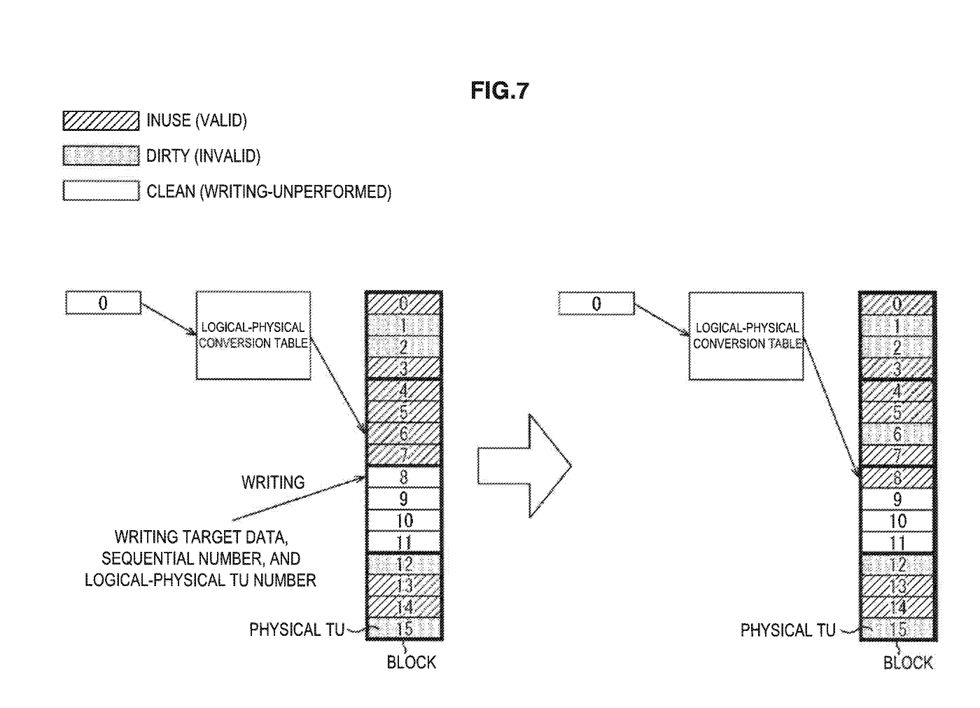

FIG. 7 is a diagram for describing writing of data on the flash memory 16.

When there is a request for writing data for which a logical TU number is designated from the file system 21, the logical-physical conversion library 22 (of FIG. 2) recognizes writing-unperformed physical TUs (of which a state is CLEAN) with reference to the state map, and then writes data for which writing is requested (hereinafter, also referred to as writing target data) in the physical TUs.

Further, in the physical TUs in which the writing target data is written, the logical-physical conversion library 22 writes sequential numbers allotted to the blocks that includes the physical TUs and the logical TU numbers designated by the file system 21 as part of the management information.

In other words, logical TUs having logical TU numbers designated by the file system 21 are allotted to the physical TUs in which the writing target data is written, and the logical TU numbers of the logical TUs allotted to the physical TUs are written in the physical TUs in which the writing target data is written as part of the management information.

In addition, the logical-physical conversion library 22 updates the logical-physical conversion table and the state map so that the management information written in the physical TUs in which the writing target data is written is reflected thereon.

In FIG. 7, the file system 21 makes a request for writing data on the logical TU #0.

In FIG. 7, the logical TU #0 is associated with the physical TU #6 in the logical-physical conversion table, however, in the logical-physical conversion library 22, the logical TU #0 is allotted to, for example, the physical TU #8 among the writing-unperformed physical TUs which can be recognized with reference to the state map, and writing target data that is expected to be written in the logical TU #0 is written therein together with the management information.

As described above, when the writing target data and the management information are written in the writing-unperformed physical TU #8, data written in the physical TU #6 associated with the logical TU #0 turns into invalid data in the logical-physical conversion table.

Then, in FIG. 7, the logical-physical conversion table is updated so that the logical TU #0 is associated with the physical TU #8 in which the writing target data is written.

### <Fold Process of the Flash Memory 16>

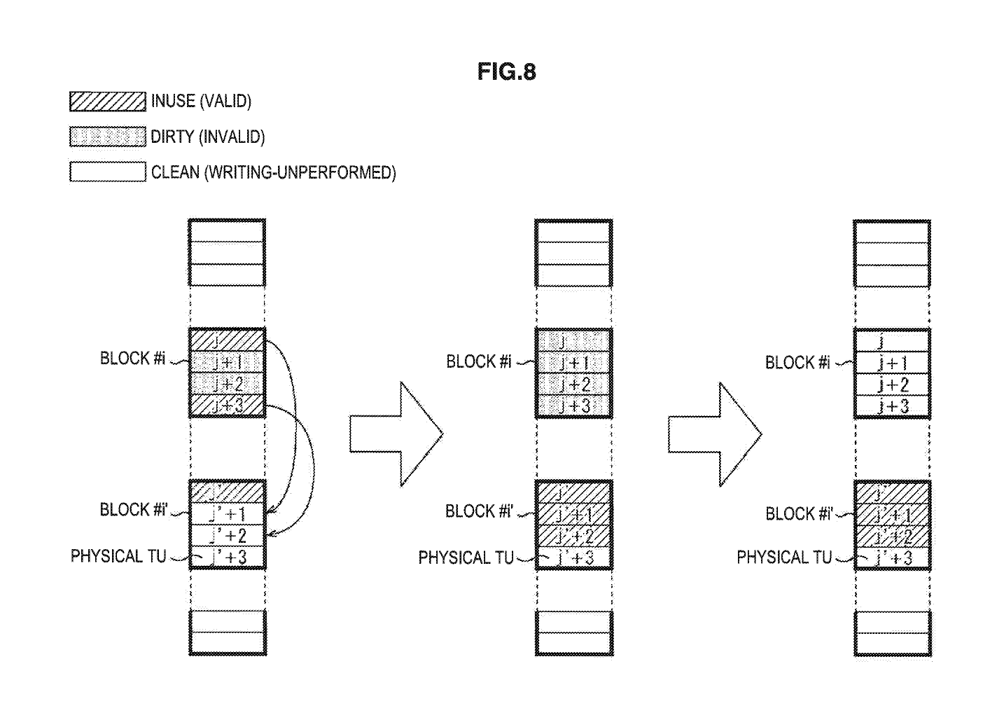

FIG. 8 is a diagram for describing a fold process of the flash memory 16.

As described in FIG. 7, writing of data on a logical TU is performed in the flash memory 16 by writing data in a writing-unperformed physical TU and allotting a logical TU in which writing of data is requested to the physical TU.

As a result, since the data written in the physical TU to which the logical TU is allotted turns into invalid data during writing of the data on the logical TU, as writing of data on the flash memory 16 progresses (the number of times of writing increases), the number of physical TUs in which invalid data is written increases, and the number of writing-unperformed physical TUs decreases.

On the other hand, since erasure of data (including the management information) can only be performed in units of blocks in the flash memory 16, when physical TUs (physical TUs of which a state is INUSE) in which valid data is written (hereinafter, also referred to as valid physical TUs) are present in a block, the invalid data is difficult to erase even if the block includes physical TUs in which the invalid data is written (physical TUs of which a state is DIRTY) (hereinafter, also referred to as invalid physical TUs).

Thus, the logical-physical conversion library 22 (of FIG. 2) performs the following process called a fold process in order to reduce the number of invalid physical TUs and increase the number of writing-unperformed physical TUs (or maintain a certain or higher number of them)

As illustrated in FIG. 8, in the fold process, data (valid data) written in valid physical TUs is written (copied) in writing-unperformed physical TUs so that blocks only include valid physical TUs.

By writing the data written in the valid physical TUs in the writing-unperformed physical TUs, original physical TUs (physical TUs that were valid) turn into invalid physical TUs. Then, when blocks come to only include invalid physical TUs, (invalid data written in) the blocks that only include the invalid physical TUs are erased.

In FIG. 8, among physical TUs #j to #j+3 constituting a block #1, the physical TUs #j and #j+3 are set to be valid physical TUs, and the physical TUs #1+1 and #j+2 are set to be invalid physical TUs. In addition, among physical TUs #j′ to #1+3 constituting a block #i′ which is another block, the physical TU #j′ is set to be a valid physical TU and the physical TUs #j′+1 to #j′+3 are set to be writing-unperformed physical TUs.

Then, among the physical TUs #j to #j+3 constituting the block data written in the valid physical TUs #j and #j+3 is written in each of the writing-unperformed physical TUs #j′+1 and #j′+2 constituting the block #i′, and accordingly, the physical TUs #j and #j+3 which were valid turn into invalid physical TUs, and the physical TUs #j′+1 and #j′+2 in which writing was not performed turn into valid physical TUs.

Further, as the physical TUs #j and #j+3 that were valid turn into invalid physical TUs, all of the physical TUs #j to #j+3 constituting the block #i turn into invalid physical TUs, and accordingly, (data of) the block #i that includes such invalid physical TUs is erased, and then the block #i turns into a writing-unperformed block.

### <Table and Map Creation Process>

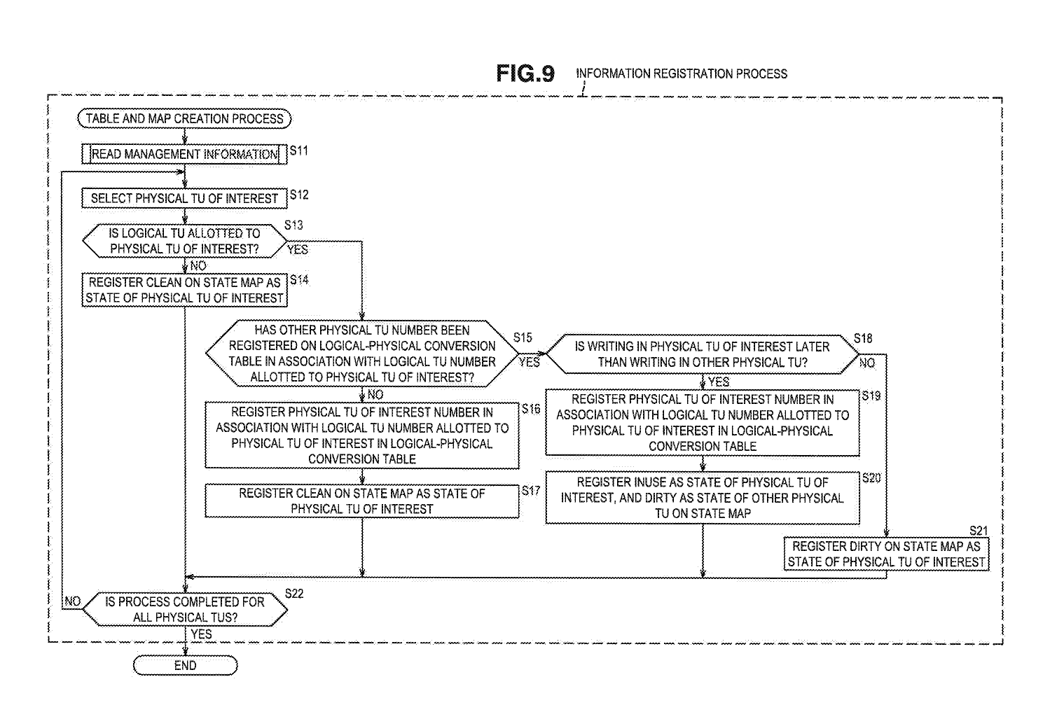

FIG. 9 is a flowchart for describing an example of a process for creating the logical-physical conversion table and the state map performed by the logical-physical conversion library 22 of FIG. 2.

When the logical-physical conversion library 22 is executed by the CPU 12, the logical-physical conversion library 22 secures a region for storing the logical-physical conversion table and the state map in the RAM 14 (of FIG. 1), and then performs the table and map creation process.

In the table and map creation process, the logical-physical conversion library 22 reads the management information from the extended region of each physical TU of the flash memory 16 via the flash memory driver 23 in Step S11, and then the process proceeds to Step S12.

In Step S12, the logical-physical conversion library 22 selects one of physical TUs that have not been selected as a physical TU of interest to be noted from the physical TUs that the flash memory 16 has, and then the process proceeds to Step S13.

In Step S13, the logical-physical conversion library 22 determines whether or not a logical TU is allocated to the physical TU of interest based on the management information read from the physical TU of interest.

When a logical TU is determined not to be allocated to the physical TU of interest in Step S13, in other words, when the management information is not written in the physical TU of interest, and thus the physical TU of interest is a writing-unperformed physical TU, the process proceeds to Step S14, and the logical-physical conversion library 22 registers CLEAN as a state of the physical TU of interest on a state map, and then the process proceeds to Step S22.

In addition, when a logical TU is determined to be allotted to the physical TU of interest in Step S13, in other words, when the management information that includes a logical TU number of the logical TU allotted to the physical TU of interest is written in the physical TU of interest, and thus the physical TU of interest is a physical TU of INUSE or DIRTY (hereinafter, also referred to as a writing-completed physical TU), the process proceeds to Step S15, and the logical-physical conversion library 22 determines whether or not a physical TU number is already registered in a logical-physical conversion table in association with the logical TU number allotted to the physical TU of interest.

In Step S15, when it is determined that the physical TU number is not registered in the logical-physical conversion table in a form in which it is associated with the logical TU number allotted to the physical TU of interest, the process proceeds to Step S16, then the logical-physical conversion library 22 registers the physical TU number of the physical TU of interest (physical TU of interest number) by associating it with the logical TU number allotted to the physical TU of interest in the logical-physical conversion table, and then the process proceeds to Step S17.

In Step S17, the logical-physical conversion library 22 registers INUSE as a state of the physical TU of interest on the state map, and the process proceeds to Step S22.

In addition, when the physical TU number is determined to have already been registered in the in the logical-physical conversion table in association with the logical TU number allotted to the physical TU of interest in Step S15, the process proceeds to Step S18, and then the logical-physical conversion library 22 determines whether or not writing data in the physical TU of interest is later than writing data in another physical TU of which a physical TU number is registered in the logical-physical conversion table in association with a logical TU number allotted to the physical TU of interest (hereinafter, also referred to as a same-registered-logical-TU-number-allotted physical TU).

Here, whether or not writing data in the physical TU of interest is later than writing data in the same-registered-logical-TU-number-allotted physical TU can be determined based on the rule of writing for defining that writing is performed in ascending order of physical TU numbers, and sequential numbers of physical TUs in a block as described in FIG. 5.

When writing data in the physical TU of interest is determined to be later than writing data in the same-registered-logical-TU-number-allotted physical TU in Step S18, the process proceeds to Step S19, then the logical-physical conversion library 22 registers the physical TU number of the physical TU of interest in association with the logical TU number allotted to the physical TU of interest, instead of the physical TU number of the same-registered-logical-TU-number-allotted physical TU, and then the process proceeds to Step S20.

In Step S20, the logical-physical conversion library 22 registers INUSE as a state of the physical TU of interest on the state map, and also registers DIRTY as a state of the same-registered-logical-TU-number-allotted physical TU, and then the process proceeds to Step S22.

In addition, when writing data in the physical TU of interest is determined not to be later than writing data in the same-registered-logical-TU-number-allotted physical TU in Step S18, the process proceeds to Step S21, then the logical-physical conversion library 22 registers DIRTY as a state of the physical TU of interest on the state map, and then the process proceeds to Step S22.

In Step S22, the logical-physical conversion library 22 determines whether or not all of the physical TUs of the flash memory 16 are selected as physical TUs of interest.

In Step S22, when it is determined that there are physical TUs which are not yet selected as physical TUs of interest among the physical TUs of the flash memory 16, the process returns to Step S12, and the same steps are repeated.

In addition, in Step S22, when all of the physical TUs of the flash memory 16 are determined to be selected as physical TUs of interest, the table and map creation process ends.

Note that the logical-physical conversion table and the state map are stored in the RAM 14, and when the TV of FIG. 1 is turned off, the logical-physical conversion table and the state map stored in the RAM 14 are lost. For this reason, every time the TV is turned on and the logical-physical conversion library 22 is executed by the CPU 12, the logical-physical conversion library 22 performs the table and map creation process to create (re-create) the logical-physical conversion table and the state map.

Here, since information of each of the physical TUs included in the flash memory 16 is registered in the logical-physical conversion table and the state map for each physical TU in Steps S12 to S22 of the table and map creation process of FIG. 9, the processes of Steps S12 to S22 are hereinafter also called an information registration process.

### <Writing of Logical TU Numbers in Physical TUs>

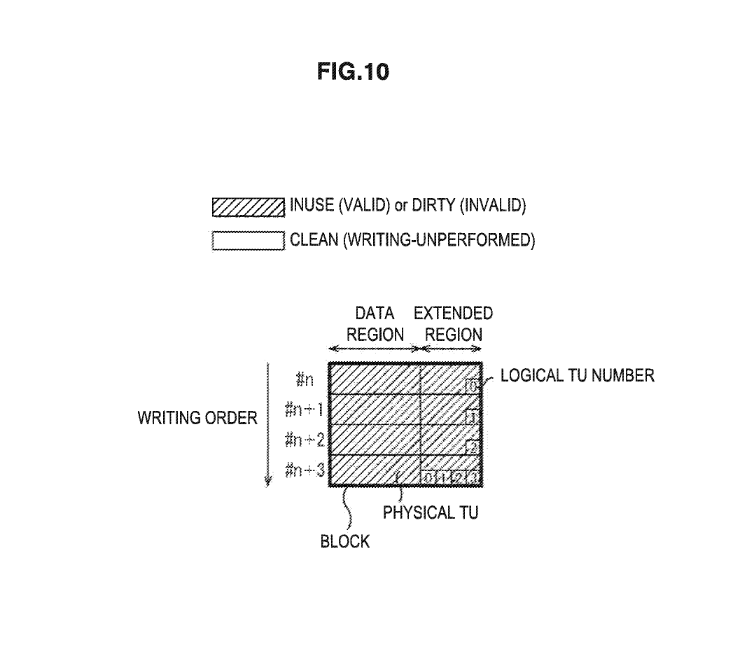

FIG. 10 is a diagram for describing an example of writing logical TU numbers in physical TUs as management information.

As described in FIG. 7, during writing of data on the flash memory 16, not only is the writing target data written in the physical TUs, but also the logical TU numbers of the logical TUs allotted to the physical TUs are written therein as (a part of) management information.

Here, when the logical TU numbers only of the logical TUs allotted to the physical TUs are written in the physical TUs as management information, reading of the management information in blocks in which writing in all physical TUs is completed should be performed for all of the physical TUs of the block in the table and map creation process, which requires time.

Thus, in writing the logical TU numbers in the physical TUs, for example, in the physical TU in which last writing is performed among physical TUs constituting a block, not only the logical TU number of the logical TU allotted to the physical TU but also all logical TU numbers of logical TUs allotted to another physical TU constituting the block can be written.

In this case, in the block, all of the logical TU numbers of the logical TUs allotted to each of the physical TUs included in the block are written in the physical TU in which last writing is performed.

In other words, as illustrated in FIG. 10, for example, when the block includes four physical TUs #n to #n+3 and writing of data in the physical TUs in the block is performed in ascending order of the physical TU numbers as described in FIG. 4, in the physical TU #n (which has the lowest physical TU number) in which first writing is performed, data is written and a logical TU number (of a logical TU) allotted to the physical TU #n is written.

Then, in the physical TU #n+1 (which has the second lowest physical TU number) in which second writing is performed, data is written and a logical TU number allotted to the physical TU #n+1 is written, and next, in the physical TU #n+2 in which third writing is performed, data is written and a logical TU number allotted to the physical TU #n+2 is written.

In addition, in the physical TU #n+3 (which has the highest physical TU number) in which last writing is performed, data is written and a logical TU number allotted to the physical TU #n+3 and all of the logical TU numbers allotted to the physical TUs #n to #n+2 in the block are written.

In FIG. 10, the logical TU numbers of 0 to 3 are allotted to the physical TUs #n to #n+3 constituting the block, and for this reason, all of 0 to 3 which are the logical TU numbers allotted respectively to the physical TUs #n to #n+3 are written in the physical TU #n+3 in which last writing is performed.

Here, as described above, the method for writing all logical TU numbers allotted to physical TUs constituting a block in a predetermined physical TU such as the physical TU in which last writing is performed among the physical TUs constituting the block when logical TUs (or their numbers) are allotted to all of the physical TUs constituting the block is also called an all-number-writing method.

In the all-number-writing method, when logical TUs (or their numbers) are allotted physical TUs constituting a block, all logical TU numbers allotted to the physical TUs constituting the block are written in the physical TU in which last writing is performed among the physical TUs constituting the block.

Further, since a sequential number written as management information in a physical TU constituting a block is a sequential number allotted to the block, sequential numbers written in physical TUs in the block are the same.

Thus, when the all-number-writing method is adopted and logical TUs (or their numbers) are allotted to all physical TUs constituting a block, only by reading management information from the physical TU in which writing is performed last among the physical TUs constituting the block in the table and map creation process, can the logical TU (or its number) and the sequential number allotted to each physical TU constituting the block be recognized for each physical TU without reading management information from other physical TUs.

As a result, the time for reading the management information in the table and map creation process can be reduced, and further, an activation time taken until reading and writing of data from and on the flash memory 16 can be shortened in the access control unit (of FIG. 2).

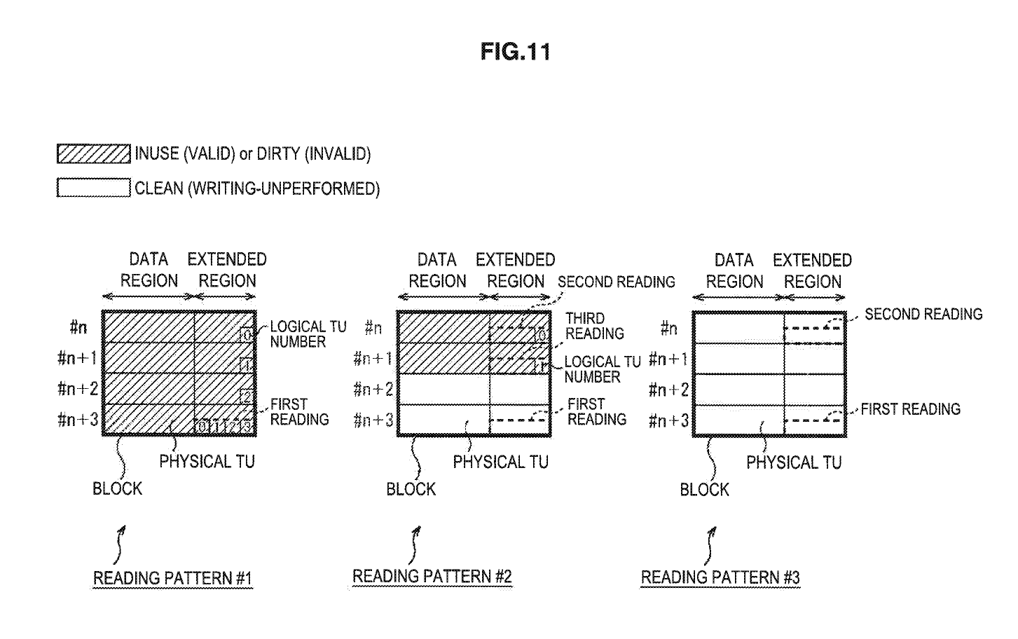

FIG. 11 is a diagram for describing a reading pattern of reading of management information from a block when the all-number-writing method is adopted.

When the all-number-writing method is adopted and when all physical TUs constituting a block are writing-completed physical TUs (physical TUs in the state of INUSE or DIRTY), in other words, when logical TUs (or their numbers) are allotted to all of the physical TUs constituting the block, all of the logical TU numbers allotted to the physical TUs constituting the block are written in the physical TU in which last writing is performed, and thus the management information may only be read from the physical TU in which the last writing is performed.

On the other hand, when only some physical TUs rather than all of the physical TUs constituting the block are writing-completed physical TUs, the management information is not written in the physical TU in which the last writing is performed (hereinafter, also referred to as the last physical TU) in the block, but the management information is written only in the writing completed physical TUs.

Thus, when only some physical TUs rather than all of the physical TUs constituting the block are writing-completed physical TUs, in other words, when the last physical TU is a writing-unperformed physical TU, it is necessary to read the management information from the writing-completed physical TUs among the physical TUs constituting the block.

In addition, when writing of data in the physical TUs in the block is performed in ascending order of the physical TU numbers, it is efficient to perform reading of the management information from the writing-completed physical TUs in ascending order of the physical TU numbers as the order of writing.

Based on the above description, when the all-number-writing method is adopted, the logical-physical conversion library 22 first reads the management information from the last physical TU for each block, and when the management information is not written in the last physical TU, the management information is read from the physical TUs in ascending order of the physical TU numbers as the order of writing.

For this reason, when the all-number-writing method is employed, for patterns of reading the management information from a block, there are three patterns of reading patterns #1, #2, and #3 as illustrated in FIG. 11.

The reading pattern #1 is a reading pattern when all physical TUs constituting a block are writing-completed physical TUs (physical TUs in a state of INUSE or DIRTY), in other words, a reading pattern when logical TUs (or their numbers) are allotted to all of the physical TUs constituting the block.

In this case, since all of the logical TU numbers allotted to the physical TUs constituting the block are written in the last physical TU of the block, the management information may only be read from the physical TU in which the last writing is performed.

Thus, in the reading pattern #1, when the management information can be read from the last physical TU of the block, reading of the management information from the physical TUs constituting the block is finished.

The reading pattern #2 is a pattern when only some physical TUs rather than all of the physical TUs constituting the block are writing-completed physical TUs.

When only some physical TUs rather than all of the physical TUs constituting the block are writing-completed physical TUs, since the management information is written in the last physical TU of the block, it is not possible to read the management information from the last physical TU.

For this reason, in the reading pattern #2, after reading of the management information from the last physical TU of the block is performed, reading of the management information from the physical TUs is started in ascending order of the physical TU numbers.

Then, in the reading pattern #2, until reading of the management information from the physical TUs is no longer possible, in other words, until reading of the management information from the physical TUs in which the management information is not written is performed, reading of the management information from the physical TUs is performed in ascending order of the physical TU numbers.

The reading pattern #3 is a reading pattern when all of the physical TUs constituting the block are writing-unperformed physical TUs.

When all of the physical TUs constituting the block are writing-unperformed physical TUs, the management information is not written in all of the physical TUs including the last physical TU of the block, and thus it is not possible to read management information from the last physical TU.

For this reason, in the reading pattern #3, in the same manner as in the reading pattern #2, after reading of the management information from the last physical TU of the block is performed, reading of the management information from the physical TUs is started in ascending order of the physical TU numbers.

However, when all of the physical TUs constituting the block are writing-unperformed physical TUs, the management information is not written in the physical TU in which the first writing is performed in the block (in this case, a physical TU having the lowest physical TU number in the block) (hereinafter, also referred to as the first physical TU).

For this reason, in the reading pattern #3, after reading of the management information from the physical TUs is started in ascending order of the physical TU numbers, it is not possible to perform reading of the management information from the first physical TU for which reading of the management information is to be performed first, and at that point, reading of the management information from the physical TUs constituting the block is finished.

The time required for reading the management information from the block is the shortest in the reading pattern #1 and the second shortest in the reading pattern #3. The reading pattern #2 in which reading of the management information can be performed (reading of the management information can be attempted) from all of the physical TUs of the block requires the longest time for reading the management information from the block.

### <Reading of Management Information>

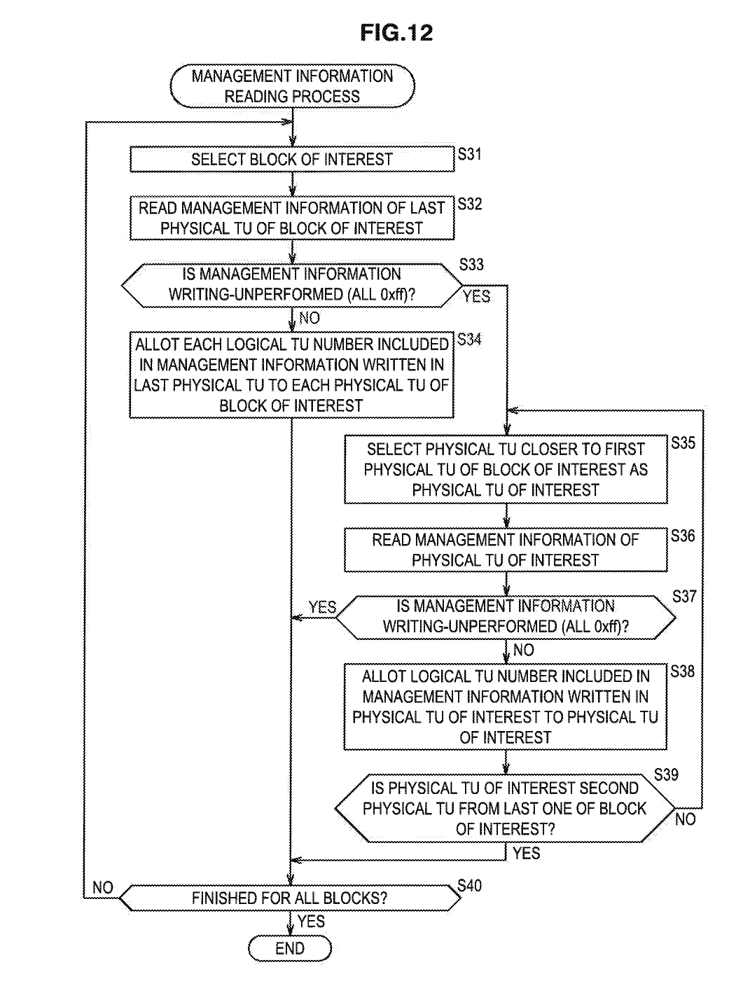

FIG. 12 is a flowchart for describing a process of reading management information from physical TUs (hereinafter, also referred to as a management information reading process) performed in Step S11 of the table-map creation process of FIG. 9 when the all-number-writing method is employed.

In the management information reading process, the logical-physical conversion library 22 selects one of blocks that is not yet selected as a block of interest to be noted among blocks that the flash memory 16 has in Step S31, and the process proceeds to Step S32.

In Step S32, the logical-physical conversion library 22 reads management information of the last physical TU of the block of interest, and the process proceeds to Step S33.

In Step S33, the logical-physical conversion library 22 determines whether the management information of the last physical TU of the block of interest has yet to be written.

When the management information of the last physical TU of the block of interest is determined not to be written in Step S33, in other words, when the management information is written in the last physical TU of the block of interest but is not read, the process proceeds to Step S34, then the logical-physical conversion library 22 allots logical TU numbers to each of physical TUs of the block of interest based on the management information read from the last physical TU of the block of interest, and then the process proceeds to Step S40.

In other words, when the management information is written in the last physical TU of the block of interest, since the management information includes all logical TU numbers of logical TUs allotted to each of the physical TUs of the block of interest, the logical TU numbers included in the management information are allotted to all of the physical TUs of the block of interest based on the management information in Step S34.

On the other hand, when the management information of the last physical TU of the block of interest is determined not to be written in Step S33, in other words, when all information pieces read as the management information from the last physical TU of the block of interest are a bit string written at the time of erasure of blocks, for example, 0xff, the process proceeds to Step S35, then the logical-physical conversion library 22 selects, as a physical TU of interest, a physical TU that is closer to the first physical TU (a physical TU having a lower physical TU number) among physical TUs that are not yet selected as a physical TU of interest among the physical TUs of the block of interest, and then the process proceeds to Step S36.

In Step S36, the logical-physical conversion library 22 reads the management information of the physical TU of interest, and the process proceeds to Step S37.

In Step S37, the logical-physical conversion library 22 determines whether the management information of the physical TU of interest has yet to be written.

In Step S37, when the management information of the physical TU of interest is determined not to be written, in other words, when all information pieces read as the management information from the physical TU of interest are obit string written at the time of erasure of blocks, for example, 0xff, the management information will not be written in the succeeding physical TUs (physical TUs having higher physical TU numbers) to the physical TU of interest in which the management information is not written in the block of interest, and thus the process proceeds to Step S40, skipping a loop process of Steps S35 to S39 in which reading of the management information is performed.

In addition, in Step S37, when the management information of the physical TU of interest is determined to be written, in other words, when the management information is written in the physical TU of interest and read, the process proceeds to Step S38, then the logical-physical conversion library 22 allots a logical TU number included in the management information to the physical TU of interest based on the management information read from the physical TU of interest, and the process proceeds to Step S39.

In Step S39, the logical-physical conversion library 22 determines whether or not the physical TU of interest is the second physical TU from the last one (the physical TU one before the last physical TU) of the block of interest.

In Step S39, when the physical TU of interest is determined to be the second physical TU from the last one of the block of interest, in other words, when there is a physical TU that is not yet selected as a physical TU of interest among the physical TUs except for the last physical TU of the block of interest, the process returns to Step S35, and a loop process of Steps S35 to S39 is repeated thereafter.

In addition, in Step S39, when the physical TU of interest is determined to be the second physical TU from the last one of the block of interest, in other words, when all of the physical TUs except for the last physical TU of the block of interest are selected as the physical TUs of interest, the process proceeds to Step S40, and the logical-physical conversion library 22 determines whether or not all blocks of the flash memory 16 are to be selected as blocks of interest.

In Step S40, when it is determined that there is a block that is not yet selected as a block of interest among the blocks of the flash memory 16, the process returns to Step S31, and the same processes are repeated thereafter.

In addition, in Step S40, it is determined that all of the blocks of the flash memory 16 are selected as blocks of interest, the management information reading process ends.

### <State of the Flash Memory 16>

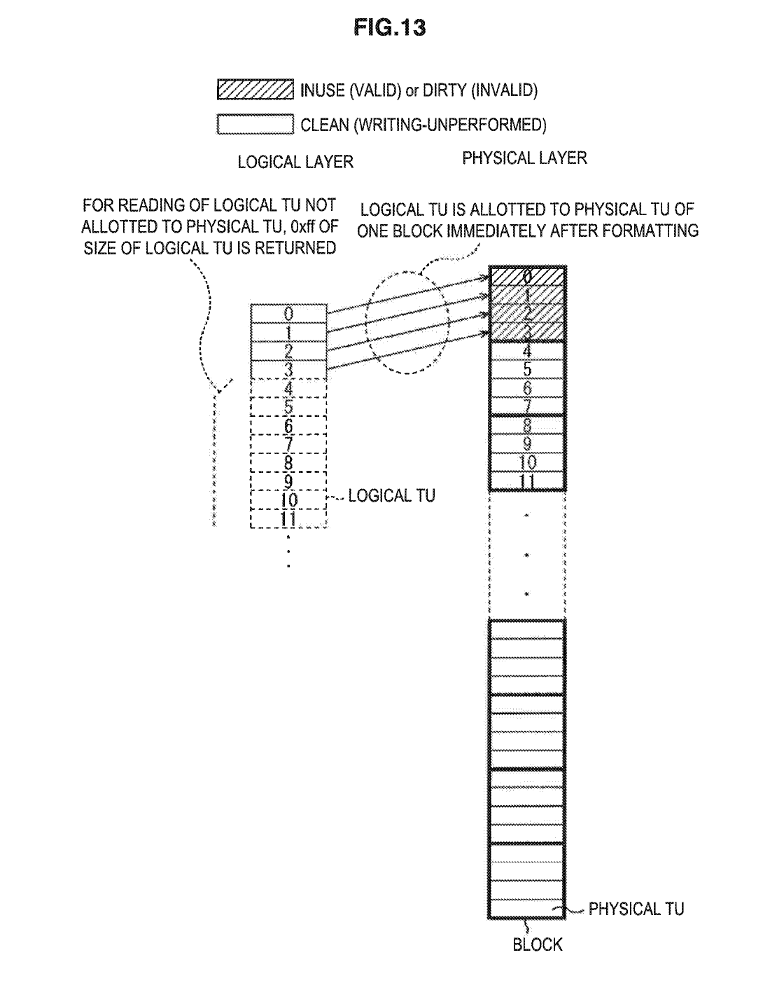

FIG. 13 is a diagram illustrating an example of a state of the flash memory 16 after formatting.

The logical-physical conversion library 22 formats the flash memory 16 according to an instruction, or the like from the outside.

In formatting of the flash memory 16, the logical-physical conversion library 22 allots and writes logical TUs (or the number) as part of the management information in each of physical TUs of one block, for example, a first block (having the lowest block number) of the flash memory 16, so that formatting of the flash memory 16 can be recognized.

Thus, immediately after the formatting, logical TUs are not allotted to physical TUs other than the physical TUs of the first block of the flash memory 16, and the management information is not written therein either.

In FIG. 13, the logical TUs #0 to #3 are allotted respectively to the physical TUs #0 to #3 constituting the first block of the flash memory 16, accordingly, the physical TUs #0 to #3 turn into writing-completed physical TUs (physical TUs of which the states are either INUSE or DIRTY), and other physical TUs are writing-unperformed physical TUs (physical TUs of which the states are CLEAN).

Note that, in consideration of a defect of a physical TU, the logical-physical conversion library 22 prepares a number of logical TUs corresponding to 95% or more than the number of physical TUs that the flash memory 16 has (or provides them to external units such as the file system 21, or the like).

When there is a request for reading a logical TU that is not allotted to a physical TU, the logical-physical conversion library 22 returns, for example, a bit string in which 0xff is arranged as long as the size of the logical TU as a bit string indicating writing-unperformed (erasure-completed).

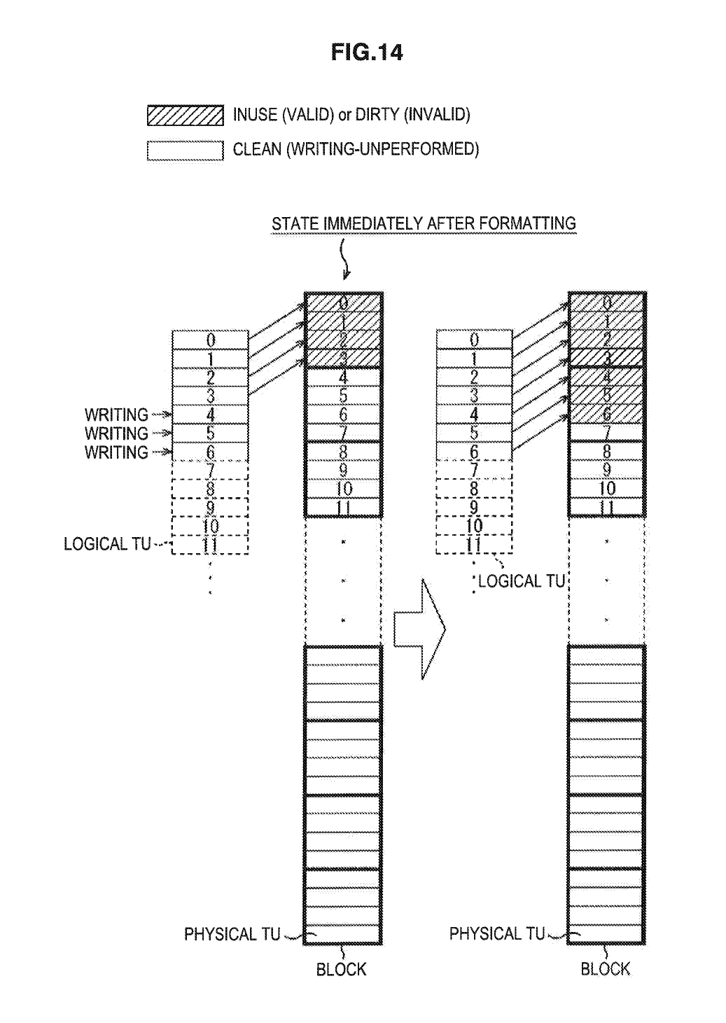

FIG. 14 is a diagram illustrating an example of a state in which data is written in a few physical TUs after the flash memory 16 is formatted.

When there is a request for writing data in a logical TU from an external unit, the logical-physical conversion library 22 writes data in a writing-unperformed physical TU, and allots a logical TU thereto.

In FIG. 14, after formatting, there is a request for writing data in logical TUs #4, #5, and #6, data is written in physical TUs #4, #5, and #6 which are writing-unperformed physical TUs according to the request, and the logical TUs #4, #5, and #6 are respectively allotted thereto. During writing of data in the physical TU #4, management information including the logical TU number of the logical TU #4 allotted to the physical TU #4 is also written. The same applies to writing of data in the physical TUs #5 and #6.

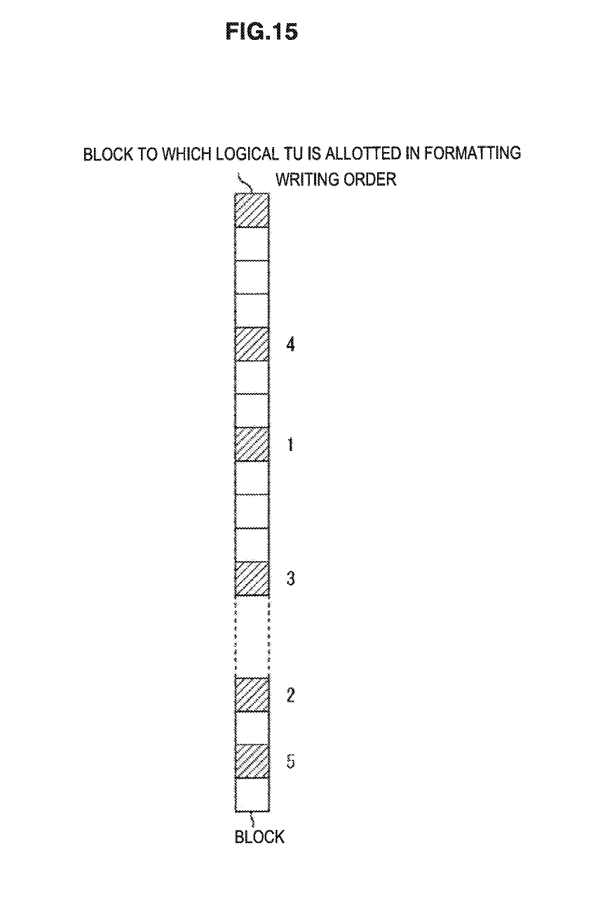

FIG. 15 is a diagram for describing writing of data on the flash memory 16.

There is an upper limit on the number of rewriting times of a block of the flash memory 16. For this reason, the logical-physical conversion library 22 performs random selection of blocks in which data is written from writing-unperformed blocks as wear-leveling that causes the blocks in which data is written not to be weighted toward specific blocks as illustrated in FIG. 15.

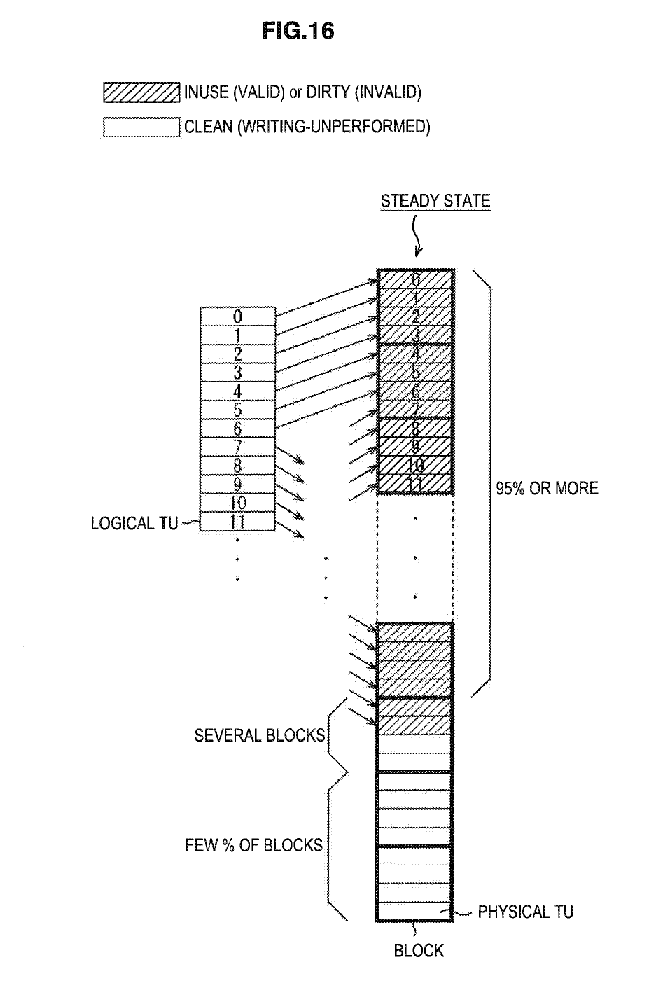

FIG. 16 is a diagram illustrating an example of a state in which, after the flash memory 16 is formatted, writing of data progresses and then some blocks turn into writing-completed blocks.

In FIG. 16, 95% or more blocks of the flash memory 16 are writing-completed blocks. In addition, in several blocks among the writing-completed blocks, some physical TUs are writing-unperformed physical TUs, but in most remaining blocks, all physical TUs are writing-unperformed TUs.

In addition, in FIG. 16, several % of blocks are writing-unperformed blocks.

Here, after the formatting, a state of the flash memory 16 after writing is performed one or more times in almost all blocks of the flash memory 16, in other words, a state of the flash memory 16 of which a number of blocks corresponding to a predetermined threshold value of the number, of blocks (hereinafter, also referred to as a threshold value of the number of blocks) turn into writing-completed blocks, is also called a steady state.

The threshold value of the number of blocks can be decided, for example, in consideration of the number of defective blocks in the life of the flash memory 16 as its specifications. As the threshold value of the number of blocks, a value that can be regarded as almost all of the number of blocks of the flash memory 16, for example, a value of 95% of the number of blocks of the flash memory 16, can be employed.

After the flash memory 16 is put in the steady state, the logical-physical conversion library 22 performs the fold process as described in FIG. 8 so that a writing-unperformed block does not disappear and the number of writing-completed blocks is maintained in the range of the threshold value of the number of blocks.

As a result, once the flash memory 16 is put in the steady state, the steady state is maintained unless formatting is performed.

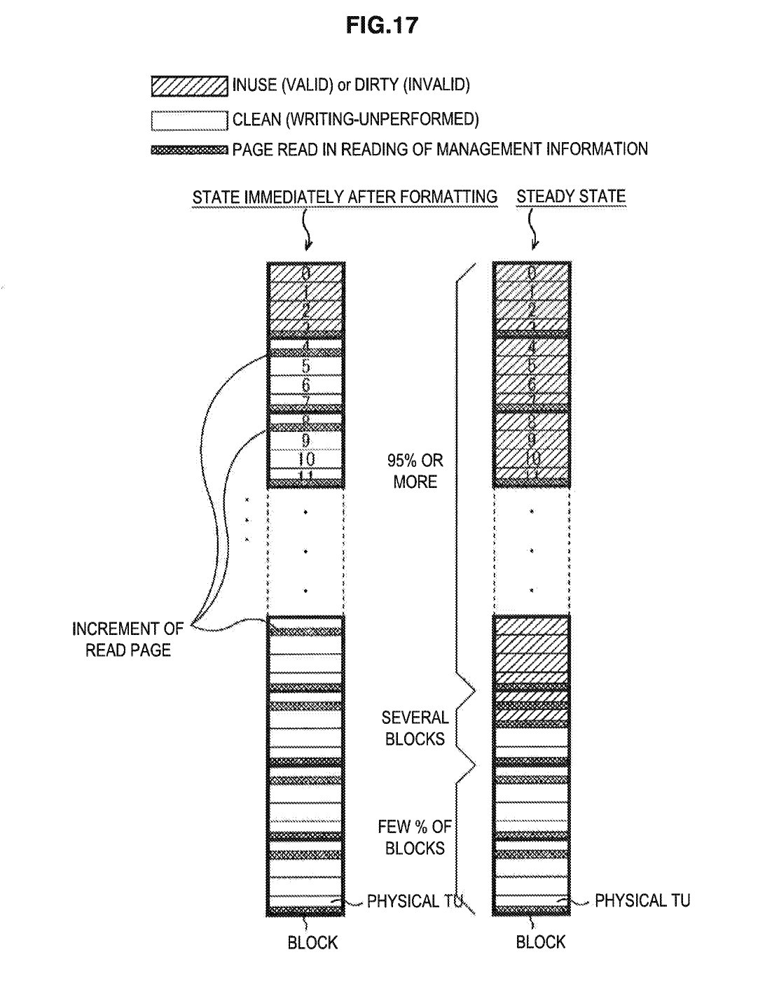

FIG. 17 is a diagram for describing reading of the management information during the table and map creation process in a state immediately after formatting of the flash memory 16 and the steady state.

Immediately after formatting, only the first block of the flash memory 16 is the block of which all physical TUs are writing-completed physical TUs, and other blocks are writing-unperformed blocks as illustrated in FIG. 13.

Thus, immediately after formatting, reading of the management information is performed for the first block in the reading pattern #1 (of FIG. 11) only for reading the management information from the last physical TU of the first block.

However, for the remaining writing-unperformed blocks, in other words, all of the blocks except for the first block of the flash memory 16, reading of the management information is performed in the reading pattern #2 (of FIG. 11) for performing reading of the management information from the last physical TU of a block and then performing reading of the management information from the first physical TU of the block.

On the other hand, as illustrated in FIG. 16, most blocks of the flash memory 16 are blocks of which all of physical TUs are writing-completed physical TUs in the steady state.

Thus, in the steady state, for most blocks, reading of the management information is performed in the reading pattern #1 (of FIG. 11) only for reading the management information from the last physical TU of a block, and for remaining blocks, reading of the management information in the reading patterns #2 and #3 is performed.

Thus, whereas reading of management is performed in the reading pattern #1 only for reading the management information from the last physical TU of a block for most of the blocks of the flash memory 16, reading management information from the last physical TU of the block is performed for all of the blocks except for the first blocks of the flash memory 16 immediately after formatting, and then reading of the management information is performed in the reading pattern #2 in which reading of the management information from the first physical TU of the block is performed.

As a result, immediately after formatting, it takes more time to perform reading of management not only due to reading of the management information from the last physical TU of a block but also due to reading of the management information from the first physical TU of the block for all of the blocks except for the first block of the flash memory 16 than in the steady state.

In other words, in general, whereas reading of the management information only from the last physical TUs of each of the blocks of the flash memory 16 is performed in the steady state, reading of the management information respectively from two physical TUs, which are the first and the last ones, of the blocks of the flash memory 16 is performed immediately after formatting, and therefore the reading of the management information immediately after formatting requires almost twice as much time as the reading of the management information in the steady state.

As described above, since the reading of the management information immediately after formatting takes longer than in the steady state, creation of the logical-physical conversion table (table and map creation process) takes longer, and as a result, activation time until reading and writing of data from and on the flash memory 16 are possible (hereinafter, also referred to as a flash memory activation time) is lengthened.

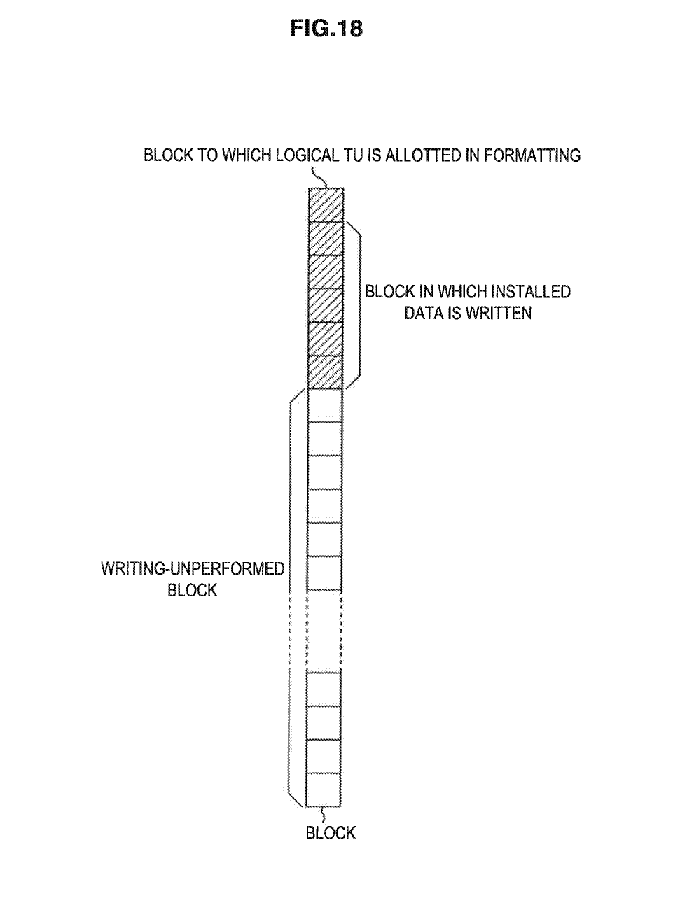

FIG. 18 is a diagram illustrating an example of a state of the flash memory 16 mounted in the TV (of FIG. 1) when it is released from a factory.

When the flash memory 16 is released from a factory, applications, and the like of the TV are installed in the flash memory 16 as installed data after it is formatted, but still, merely about, for example, a few dozen percent of blocks have physical TUs all of which are writing-completed TUs, and most blocks of the flash memory 16 are writing-unperformed blocks.

Thus, after release of the flash memory, the flash memory activation time is long until a user purchases and uses the TV and then the flash memory 16 enters the steady state.

Thus, the present technology enables the flash memory activation time to be shortened even immediately after formatting as in the steady state.

### <Configuration Example of the Logical-Physical Conversion Library 22>

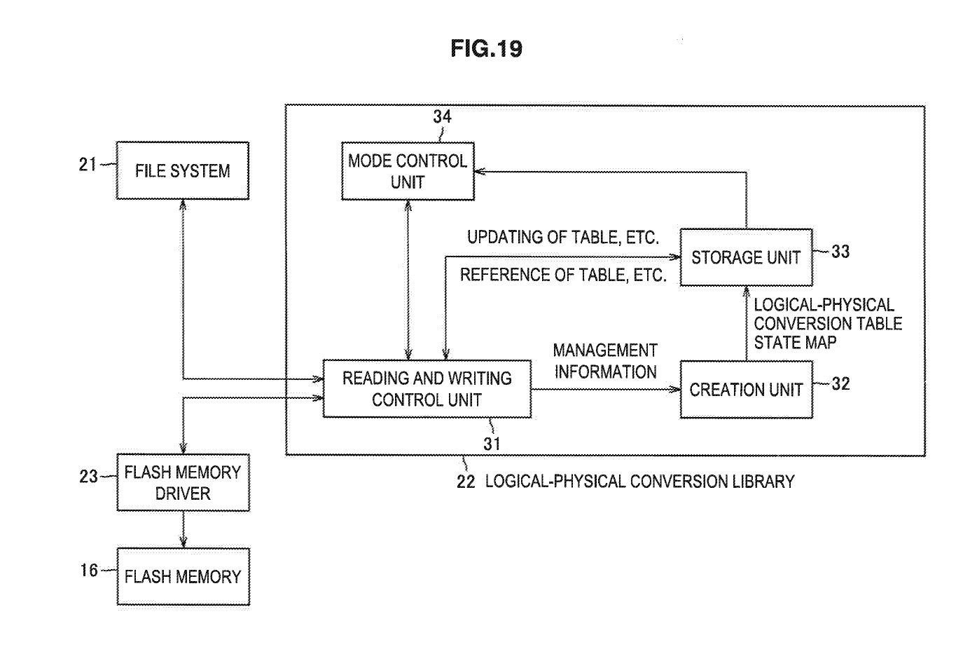

FIG. 19 is a block diagram illustrating a functional configuration example of the logical-physical conversion library 22 of FIG. 2.

In FIG. 19, the logical-physical conversion library 22 has a reading and writing control unit 31, a creation unit 32, a storage unit 33, and a mode control unit 34.

The reading and writing control unit 31 controls reading and writing of data (including management information) from and on the flash memory 16 via the flash memory driver 23 according to requests from external units such as the file system 21.

In other words, the reading and writing control unit 31 controls the flash memory driver 23 according to requests from external units such as the file system 21 so as to perform reading and writing of data (including management information) from and on the flash memory 16.

For example, according to a request for writing writing target data from the file system 21, the reading and writing control unit 31 writes the writing target data and the management information on the flash memory 16.

In addition, according to a request for reading data from the file system 21, for example, the reading and writing control unit 31 reads the data from the flash memory 16, and supplies the data to the file system 21.

Additionally, the reading and writing control unit 31 reads the management information from the flash memory 16 and supplies the information to the creation unit 32 during activation.

In addition, the reading and writing control unit 31 reads order information from the flash memory 16, and supplies the information to the mode control unit 34.

Here, the order information indicates an order of blocks in which data is to be written during writing of data on the flash memory 16, and is written on the flash memory 16 during, for example, formatting of the flash memory 16.

In other words, the reading and writing control unit 31 allots logical TUs (or the numbers) to each physical TU of the first block of the flash memory 16 and writes them as part of the management information therein during formatting of the flash memory 16 so that formatting of the flash memory 16 can be recognized as described in FIG. 13.

Further, when writing the management information including the logical TU numbers allotted to each of the physical TUs of the first block of the flash memory 16 during formatting of the flash memory, the reading and writing control unit 31 writes the order information in, for example, the physical TU for which reading of the management information is performed first in the table and map creation process among the physical TUs of the first block, that is, the last physical TU of the first block as part of the management information.

Note that an order which can be determined according to a predetermined rule, for example, ascending order or descending order of block numbers, or an order of every other block number, rather than a random order, is employed as an order indicating order information during formatting.

Here, for the sake of simplifying the description, for example, ascending order of the block numbers is employed as the order indicating the order information during formatting.

The creation unit 32 creates the logical-physical conversion table and the state map based on the management information supplied from the reading and writing control unit 31, and then supplies them to the storage unit 33 as described in FIG. 5.

The storage unit 33 stores the logical-physical conversion table and the state map supplied from the creation unit 32.

Here, the reading and writing control unit 31 performs (control of) reading and writing of data from and on the flash memory 16 referring to the logical-physical conversion table and the state map stored in the storage unit 33 if necessary.

In addition, after writing or erasing and the fold process of data of the flash memory 16, the reading and writing control unit 31 updates the logical-physical conversion table and the state map stored in the storage unit 33 so as to match the state of the flash memory 16 after writing or erasing and the fold process of data, if necessary.

Note that the storage unit 33 corresponds to, for example, a part of the memory area of the RAM 33 (of FIG. 1). Thus, the logical-physical conversion table and the state map stored in the storage unit 33 are lost when the TV of FIG. 1 is turned off.

The mode control unit 34 sets a writing mode for writing of data on the flash memory 16 based on the order information supplied from the reading and writing control unit 31, and controls the reading and writing control unit 31 so that reading of data on the flash memory 16 is performed in the writing mode.

Here, when the order indicating the order information is broadly divided, there are an order that can be determined according to a predetermined rule (hereinafter, also referred to as an order based on a rule) such as ascending order of block numbers and a random order that is difficult to determine according to a rule.

When the order information indicates the order based on a rule, the mode control unit 34 sets the writing mode to be a mode for selecting writing target blocks that are blocks in which data is to be written from writing-unperformed blocks (hereinafter, also referred to as a post-format mode) in the order based on a rule indicated by the order information, and then controls the reading and writing control unit 31 so as to be operated in the post-format mode.

Thus, in the post-format mode, the reading and writing control unit 31 selects the writing target blocks from the writing-unperformed blocks in the order based on a rule indicated by the order information.

In addition, when the order information indicates a random order, the mode control unit 34 sets the writing mode to be a mode for selecting writing target blocks from the writing-unperformed blocks in the random order indicated by the order information, in other words, a mode for randomly selecting writing target blocks from the writing-unperformed blocks for wear-leveling (hereinafter, also referred to as a normal mode) as described in FIG. 15, and then controls the reading and writing control unit 31 so as to be operated in the normal mode.

Thus, in the normal mode, the reading and writing control unit 31 randomly selects writing target blocks from the writing-unperformed blocks.

Note that, in addition to that, the mode control unit 34 controls the reading and writing control unit 31 so that the number of writing-completed blocks in the flash memory 16 is recognized by monitoring the state map stored in the storage unit 33, and the order information written on the flash memory 16 is re-written based on the number of writing-completed blocks.

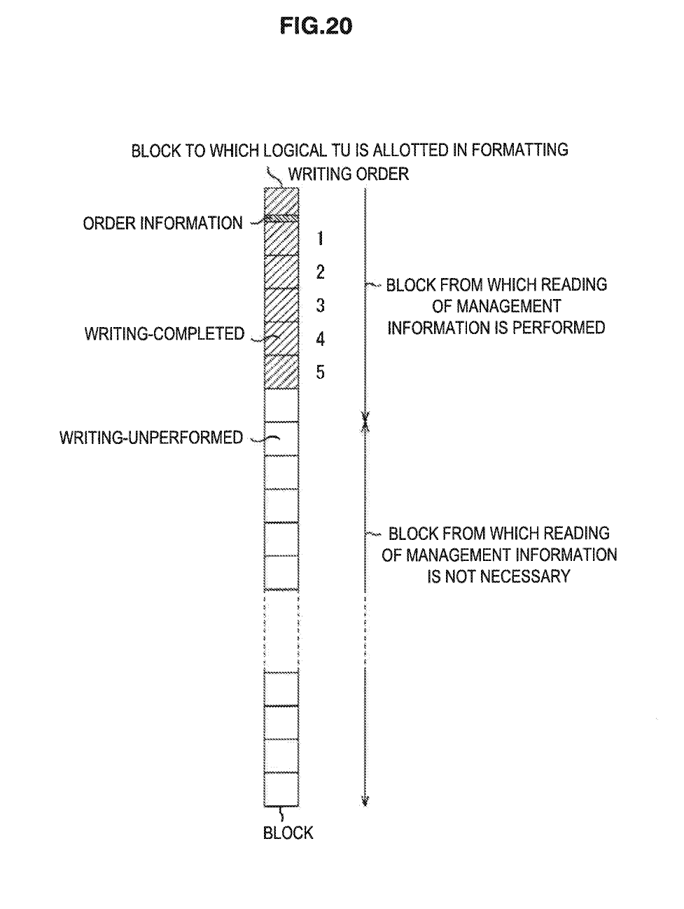

FIG. 20 is a diagram illustrating an example of a stage of the flash memory 16 when a writing mode is the post-format mode.

In FIG. 20, during formatting, for example, the order information indicating ascending order of the block numbers is written as part of the management information in the last physical TU of the first block of the flash memory 16, and is not re-written or changed as is in the formatting.

Thus, the writing mode is the post-format mode.

In the post-format mode, the reading and writing control unit 31 selects writing target blocks from the writing-unperformed blocks in the order based on a rule indicated by the order information, which is ascending order of the block numbers in this case, and writes data therein.

Thus, in the post-format mode, when management information is read from the blocks in ascending order of the block numbers, if the management information is not written in a certain (physical TU of a) block, it is guaranteed that the succeeding blocks thereof are writing-unperformed blocks in which data (including the management information) is not written.

For this reason, in the post-format mode, reading of the management information is gradually performed in ascending order of the block numbers beginning from the leading block of the flash memory 16 in the table and map creation process, and the process can end when a writing-unperformed block (including a writing-unperformed physical TU) appears.

Therefore, in the post-format mode, the time required for reading the management information can be drastically shortened in comparison to the case in which reading of the management information respectively from two physical TUs which are the first and the last physical TUs of each block of the flash memory 16 is performed for almost all blocks of the flash memory 16 as the case immediately after formatting as described in FIG. 17, and further, the flash memory activation time can be shortened.

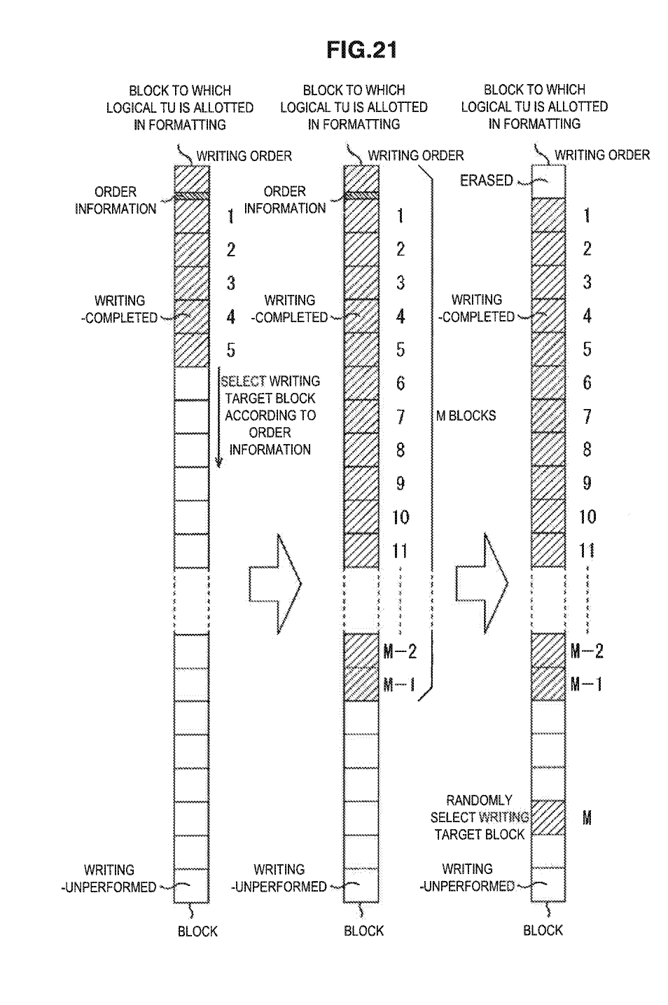

FIG. 21 is a diagram illustrating an example of a state of the flash memory 16 when the writing mode is shifted to the normal mode from the post-format mode.

As described in FIG. 20, in the post-format mode, the reading and writing control unit 31 selects the writing target blocks from the writing-unperformed blocks in ascending order of the block numbers, and writes data therein.

Thus, in the post-format mode, blocks turn into writing-completed blocks in ascending order of the block numbers as illustrated in FIG. 21.

As described in FIG. 19, the mode control unit 34 controls the reading and writing control unit 31 so that the number of writing-completed blocks in the flash memory 16 is recognized by monitoring the state map stored in the storage unit 33 and the order information written in the flash memory 16 is re-written based on the number of writing-completed blocks.

In other words, the mode control unit 34 determines whether or not the flash memory 16 is put in the steady state in which blocks of which the amount is a threshold value of the number of blocks M or more are writing-completed blocks based on the number of writing-completed blocks in the flash memory 16.

Then, when the flash memory 16 is put in the steady state, the mode control unit 34 controls the reading and writing control unit 31 so that the order information written on the flash memory 16 is re-written as order information indicating a random order.

The reading and writing control unit 31 re-writes the order information written in the leading block of the flash memory 16 so as to indicate a random order according to the control of the mode control unit 34.

Here, as the order information indicating a random order, the bit string 0xff the same as data of writing-unperformed blocks (or physical TUs) can be employed. In this case, the re-writing of the order information written in the leading block of the flash memory 16 to order information indicating a random order is completed only by erasing the (data of) leading block as illustrated in FIG. 21.

After the order information is re-written so as to indicate a random order, the mode control unit 34 sets the writing mode to be the normal mode.

In the normal mode, the reading and writing control unit 31 randomly selects writing target blocks from the writing-unperformed blocks, and writes data therein as described in FIG. 20.

### <Writing in the Normal Mode>

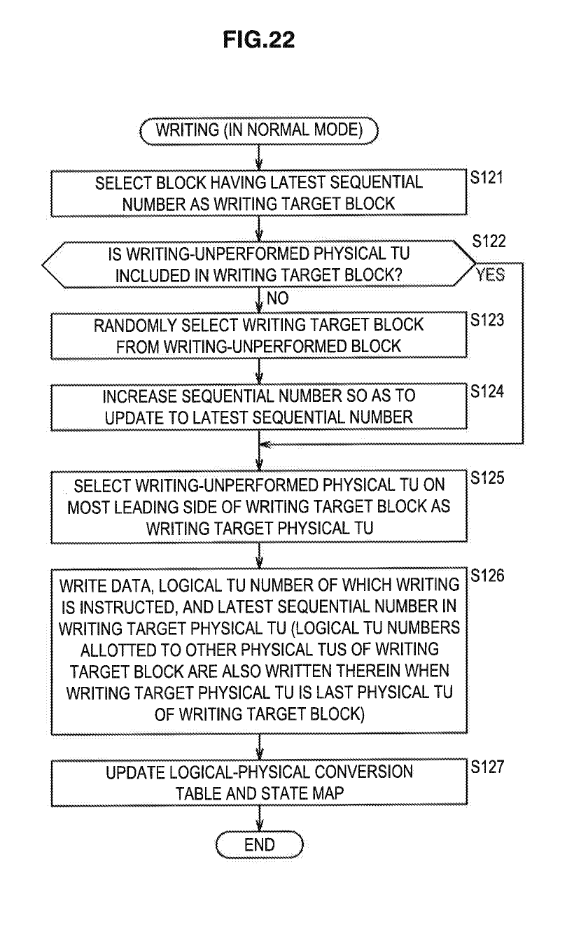

FIG. 22 is a flowchart for describing an example of a writing process of data on the flash memory 16 in the normal mode.

The writing process is started when there is a request from the file system 21 for writing writing target data to which a logical TU number is designated.

In the writing process in the normal mode, the reading and writing control unit 31 selects a block having the latest (the highest) sequential number as a writing target block with reference to the state map stored in the storage unit 33 in Step S121, and then the process proceeds to Step S122.

In Step S122, the reading and writing control unit 31 determines whether or not there is a writing-unperformed physical TU in the writing target block with reference to the state map stored in the storage unit 33.

In Step S122, when it is deter mined that there is no writing-unperformed physical TU in the writing target block, the process proceeds to Step S123, and the reading and writing control unit 31 recognizes writing-unperformed blocks with reference to the state map stored in the storage unit 33.

Further, in Step S123, the reading and writing control unit 31 randomly selects (blocks that are expected to be set as) new writing target blocks from the writing-unperformed blocks, and then the process proceeds to Step S124.

In Step S124, the reading and writing control unit 31 updates the sequential number given to the writing target block selected in Step S121 to be the latest sequential number by increasing by, for example, one, and then the process proceeds to Step S125.

In addition, in Step S122, when it is determined that there is a writing-unperformed physical TU in the writing target block, processes of Steps S123 and S124 are skipped, proceeding to Step S125, and the reading and writing control unit 31 selects the writing-unperformed physical TU at the foremost end of the writing target block (the writing unperformed physical TU having the lowest physical TU number) as a writing target physical TU to which a logical TU having a logical TU number designated by the file system 21 is allotted with reference to the state map stored in the storage unit 33, and then the process proceeds to Step S126.

In Step S126, the reading and writing control unit 31 writes the writing target data from the file system 21 in the writing target physical TU. Further, the reading and writing control unit 31 writes, in the writing target physical TU, the latest sequential number and the logical TU number of the logical TU allotted to the writing target physical TU, that is, management information including the logical TU number designated by the file system 21, and then the process proceeds to Step S127 from Step S126.

Note that, when the writing target physical TU is the last physical TU of the writing target block, all logical TU numbers of logical TUs allotted to each of other physical TUs of the writing target block in addition to the logical TU number of the logical TU allotted to the writing target physical TU are included in the management information, and then written in the writing target physical TU.

In Step S127, the reading and writing control unit 31 updates the logical-physical conversion table and the state map stored in the storage unit 33 so as to match the state of the flash memory 16 after the data is written in the writing target physical TU in Step S126, and then the writing process ends.

As described above, in the writing process in the normal mode, writing target blocks are randomly selected from writing-unperformed blocks for wear leveling, and data is written therein.

### <Writing in the Post-Format Mode>

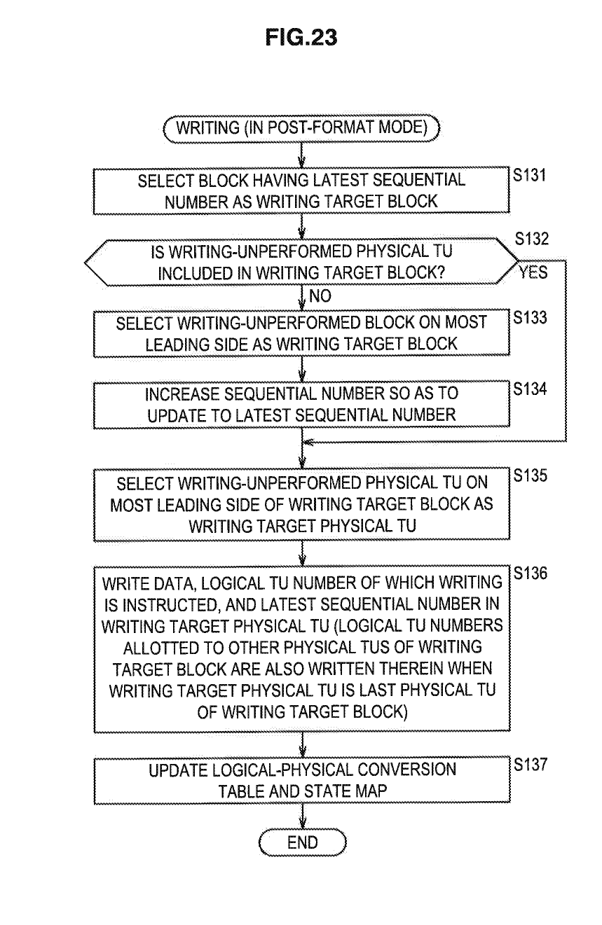

FIG. 23 is a flowchart for describing an example of a writing process of data on the flash memory 16 in the post-format mode.

The writing process is started when there is a request from the file system 21 for reading writing target data to which a logical TU number is designated as described in FIG. 22.

In addition, in the writing process in the post-format mode, the reading and writing control unit 31 selects a block having the latest (the highest) sequential number as a writing target block with reference to the state map stored in the storage unit 33 in Step S131, and then the process proceeds to Step S132.

In Step S132, the reading and writing control unit 31 determines whether or not there is a writing-unperformed physical TU in the writing target block with reference to the state map stored in the storage unit 33.

In Step S132, when it is determined that there is no writing-unperformed physical TU in the writing target block, the process proceeds to Step S133, and the reading and writing control unit 31 recognizes writing-unperformed blocks with reference to the stale map stored in the storage unit 33.

Further, in Step S133, the reading and writing control unit 31 selects a writing-unperformed block on the most leading side (having a lowest block number) from the writing-unperformed blocks as a new writing target block, and then the process proceeds to Step S134.

In Step S134, the reading and writing control unit 31 updates the sequential number given to the writing target block selected in Step S131 to be the latest sequential number by increasing by, for example, one, and then the process proceeds to Step S135.

In addition, in Step S132, when it is determined that there is a writing-unperformed physical TU in the writing target block, processes of Steps S133 and S134 are skipped, proceeding to Step S135, and then the same processes of Steps S125 to S127 of FIG. 22 are performed in Steps S135 to S137.

As described above, in the post-format mode, the writing-unperformed blocks are selected as writing target blocks in ascending order of the block numbers indicated by order information, and then data is written therein.

Thus, since data is written in the order of the block numbers and the order of the physical TU numbers in the writing process in the post-format mode, if data is not written in a physical TU of a block, it is guaranteed that data is not written in all succeeding physical TUs and blocks to the physical TU.

In other words, when a block B includes a physical TU in which management information including a logical TU number, or the like is not stored in the post-format mode, succeeding physical TUs to the physical TU of the block B in which the management information is not stored are all writing-unperformed physical TUs, and further, succeeding blocks to the block B are all writing-unperformed blocks.

### <Table and Map Creation Process>

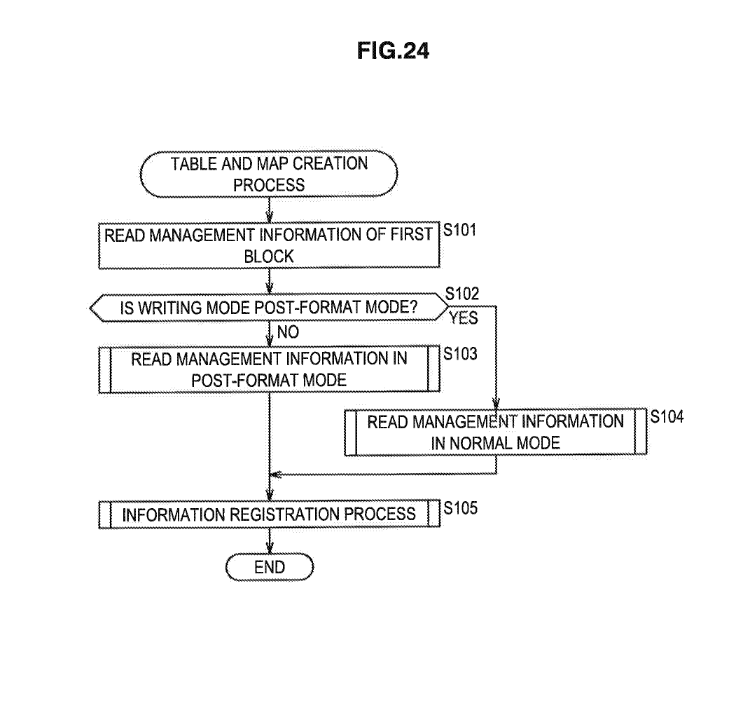

FIG. 24 is a flowchart for describing an example of the table and map creation process by the logical-physical conversion library 22 of FIG. 19.

When the logical-physical conversion library 22 is executed by the CPU 12, the logical-physical conversion library 22 secures the storage unit 33 as a region for storing a logical-physical conversion table and a state map in the RAM 14 (of FIG. 1), and performs the table and map creation process.

In the table and map creation process, the reading and writing control unit 31 reads management information written in the last physical TU of the first block of the flash memory 16, that is, management information including order information, and supplies the information to the mode control unit 34 in Step S101, and then the process proceeds to Step S102.

Here, the mode control unit 34 sets a writing mode based on the order information supplied from the reading and writing control unit 31.

In Step S102, the reading and writing control unit 31 determines whether or not the writing mode set by the mode control unit 34 based on the order information is the post-format mode.

When the writing mode is determined to be the post-format mode in Step S102, the process proceeds to Step S103, then the reading and writing control unit 31 reads the management information from the flash memory 16 in the post-format mode and supplies the information to the creation unit 32, and then the process proceeds to Step S105. A reading process of the management information in the post-format mode will be described later.

In addition, when the writing mode is determined not to be the post-format mode in Step S102, in other words, when the writing mode is the normal mode, the process proceeds to Step S104, then the reading and writing control unit 31 reads the management information from the flash memory 16 in the normal mode, supplies the information to the creation unit 32, and then the process proceeds to Step S105.

Here, the reading process of the management information in the normal mode is performed by selecting all blocks as blocks of interest in order as described in FIG. 12.

In Step S105, the creation unit 32 creates a logical-physical conversion table and a state map by performing the same information registration process as in Steps S12 to S22 of FIG. 9 using the management information from the reading and writing control unit 31, and then the table and map creation process ends.

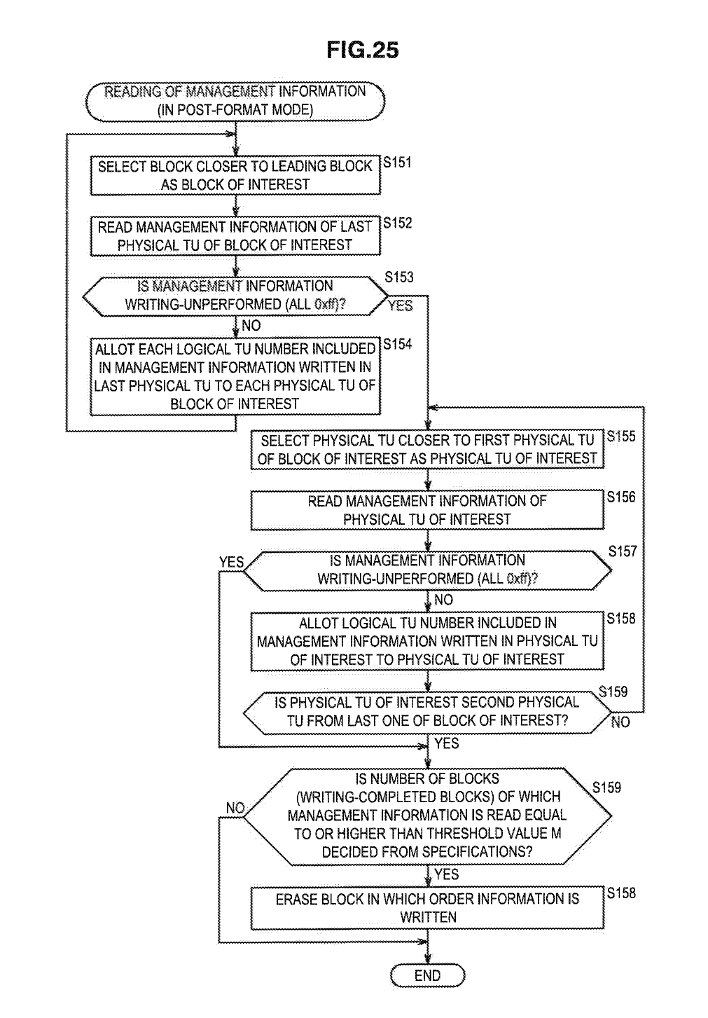

FIG. 25 is a flowchart for describing an example of a reading process of the management information in the post-format mode performed in Step S103 of FIG. 24.

In the reading process of the management information in the post-format mode, the reading and writing control unit 31 selects, as a block of interest, a block in an earlier order indicated by the order information, in other words, a block closer to the leading side in this case among blocks which the flash memory 16 has but which have not yet been selected as blocks of interest to be noted in Step S151, and then the process proceeds to Step S152.

In Step S152, the reading and writing control unit 31 reads the management information of the last physical TU of the block of interest, and then the process proceeds to Step S153.

In Step S153, the reading and writing control unit 31 determines whether the management information of the last physical TU of the block of interest has yet to be written.

When the management information of the last physical TU of the block of interest is determined not to be written in Step S153, in other words, when the management information is written in the last physical TU of the block of interest, but is not read, the process proceeds to Step S154, then the reading and writing control unit 31 allots logical TU numbers included in the management information to each physical TU of the block of interest based on the management information read from the last physical TU of the block of interest as in Step S34 of FIG. 12, and then the process returns to Step S151.

On the other hand, when the management information of the last physical

TU of the block of interest is determined not to be written in Step S153, in other words, when all information pieces read as the management information from the last physical TU of the block of interest are a bit string written during erasure of blocks, for example, 0xff, the process proceeds to Step S155, the reading and writing control unit 31 selects, as a physical TU of interest, a physical TU closer to the first physical TU (a physical TU having a lower physical TU number) among physical TUs of the block of interest which are not yet selected as a physical TU of interest, and then the process proceeds to Step S156.

In Step S156, the reading and writing control unit 31 reads the management information of the physical TU of interest, and then the process proceeds to Step S157.

In Step S157, the reading and writing control unit 31 determines whether or not the management information of the physical TU of interest is unwritten.

When the management information of the physical TU of interest is determined to be unwritten in Step S157, in other words, all information pieces read as the management information of the physical TU of interest are a bit string written during erasure of blocks, for example, 0xff, the management information is not written in succeeding physical TUs (physical TUs having higher physical TU numbers) to the physical TU of interest of the block of interest in which the management information is not written, and further, in the post-format mode, all succeeding blocks (blocks having higher block numbers) to the block that includes the physical TU in which the management information is not written are writing-unperformed blocks, and thus the process proceeds to Step S160 excluding a loop process of Steps S155 to S159 in which reading of the management information is performed.

Note that when the physical TU of interest is the first physical TU of the block of interest, and writing in the first physical TU is not performed, the block of interest is a writing-unperformed block.

On the other hand, when the management information of the physical TU of interest is determined not to be written in Step S157, in other words, the management information is written in the physical TU of interest but not read, the process proceeds to Step S158, then the reading and writing control unit 31 allots a logical TU number included in the management information to the physical TU of interest based on the management information read from the physical TU of interest, and then the process proceeds to Step S159.

In Step S159, the reading and writing control unit 31 determines whether or not the physical TU of interest is a second physical TU from the last one of the block of interest (physical TU one before the last physical TU).

When the physical TU of interest is determined not to be the second physical TU from the last one of the block of interest in Step S159, in other words, when there is a physical TU that is not yet selected as a physical TU of interest among the physical TUs except for the last physical TU of the block of interest, the process returns to Step S155, and thereafter, a loop process of Steps S155 to S159 is repeated.

In addition, when the physical TU of interest is determined to be the second physical TU from the last one of the block of interest in Step S159, in other words, when only the last physical TU is a writing-unperformed physical TU in the block of interest, all succeeding blocks to the block that includes the physical TU in which the management information is not written are writing-unperformed blocks in the post-format mode, and the process proceeds to Step S160 excluding the loop process of Steps S155 to S159 in which reading of the management information is performed.

In Step S160, the reading and writing control unit 31 determines whether or not the number of blocks in which the management information can be read, in other words, the number of writing-completed blocks, is equal to or greater than the threshold value of the number of blocks M.

When the number of writing-completed blocks is determined to be equal to or greater than the threshold value of the number of blocks M in Step S160, the reading process of the management information in the post-format mode ends.

In this case, the writing mode remains in the post-format mode.

In addition, in Step S160, when the number of writing-completed blocks is determined to be equal to or greater than the threshold value of the number of blocks M, in other words, when reading of the management information from each of two physical TUs which are the first and the last physical TUs of each block of the flash memory 16 has not been performed in almost all blocks of the flash memory 16 unlike immediately after formatting as described in FIG. 17 even though the flash memory 16 is in the steady state and the reading process of the management information in the normal mode is performed, the process proceeds to Step S161, then the reading and writing control unit 31 re-writes the order information so as to indicate a random order by erasing (data of) a block of the flash memory 16 in which the order information is written, and thereby the reading process of the management information in the post-format mode ends.

In this case, the writing mode is then shifted to the normal mode from the post-format mode.

As described in FIG. 23, when a block B has a physical TU in which the management information including a logical TU number is not stored in the post-format mode as described in FIG. 23, the succeeding physical TUs of the block B to the physical TU in which the management information is not stored are all writing-unperformed physical TUs, and further, succeeding blocks to the block B are all writing-unperformed blocks.

For this reason, when there is a block that has a physical TU in which the management information is not stored in the post-format mode, reading of the management information ends when reading of the management information from the physical TU of the block in which the management information is not stored is attempted (Steps S156 and S157).

Note that the processes of Steps S160 and S161 can be performed in the reading process of the management information in the post-format mode, or in the reading process of the management information in the post-format mode, and in the writing process in the post-format mode of FIG. 23 after the process of Step S137.

When the processes of Steps S160 and S161 are performed after the process of Step S137 in the writing process in the post-format mode of FIG. 23, the mode control unit 34 (of FIG. 19) recognizes the number of writing-completed blocks in the flash memory 16 by monitoring the state map stored in the storage unit 33, and makes the determination of Step S160 of whether or not a number of blocks corresponding to the threshold value of the number of blocks M or more are writing-completed blocks.

Then, when a number of blocks corresponding to the threshold value of the number of blocks M or more are writing-completed blocks, the mode control unit 34 controls the reading and writing control unit 31 to rewrite the order information of Step S161.

### <Other Configuration Example of the Logical-Physical Conversion Library 22>

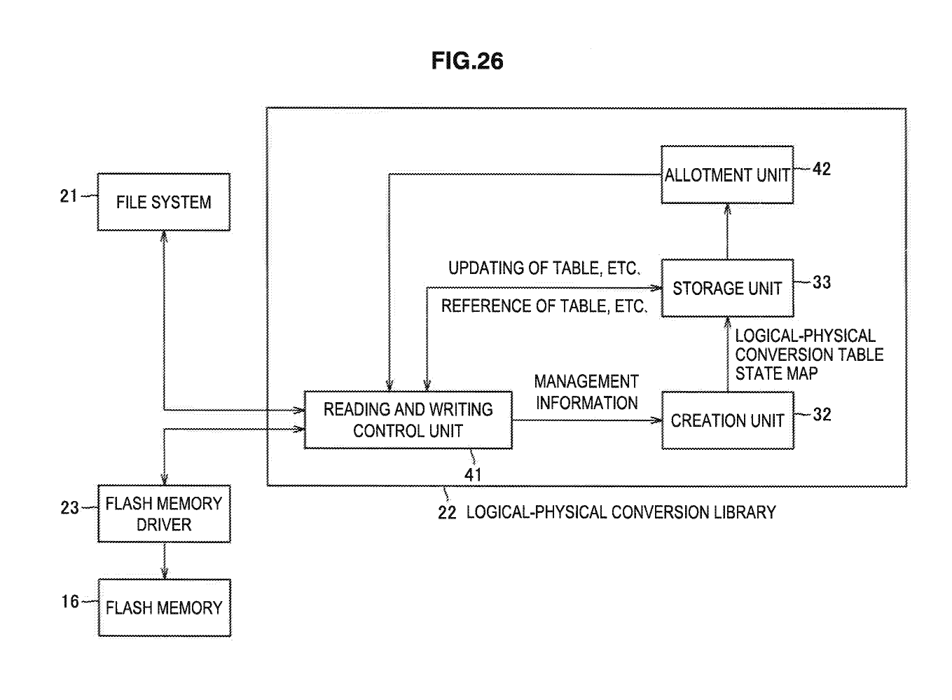

FIG. 26 is a block diagram illustrating another functional configuration example of the logical-physical conversion library 22 of FIG. 2.

Note that the same reference numerals are given to portions corresponding to those of FIG. 19 in the drawing, and description of the definition thereof is omitted herein below.

In FIG. 26, the logical-physical conversion library 22 has the creation unit 32, the storage unit 33, a reading and writing control unit 41, and an allotment unit 42.

Thus, the logical-physical conversion library 22 of FIG. 26 is the same as that of FIG. 19 in that the creation unit 32 and the storage unit 33 are included therein.

However, the logical-physical conversion library 22 of FIG. 26 is different from that of FIG. 19 in that the reading and writing control unit 41 is provided instead of the reading and writing control unit 31, the mode control unit 34 is not provided, and the allotment unit 42 is newly provided.

The reading and writing control unit 41 controls reading and writing of data (including management information) from and on the flash memory 16 through the flash memory driver 23 according to requests from external units such as the file system 21 referring to a logical-physical conversion table and a state map stored in the storage unit 33 in the same manner as the reading and writing control unit 31 of FIG. 19.

Further, like the reading and writing control unit 31 of FIG. 19, the reading and writing control unit 41 reads management information from the flash memory 16 when activated, performs a process for supplying the information to the creation unit 32, processes of writing or erasing data on or from the flash memory 16 and a fold process, and then updates the logical-physical conversion table and the state map stored in the storage unit 33 so as to match the state of the flash memory 16 after the processes of writing or erasing of the data and the fold process.

In addition, the reading and writing control unit 41 writes the management information including logical TU numbers in physical TUs of the flash memory 16 using information from the allotment unit 42.

The allotment unit 42 recognizes blocks that include writing-unperformed physical TUs in the flash memory 16 based on the state map stored in the storage unit 33, and sequentially selects a necessary number of blocks from the blocks as blocks of interest.

Further, the allotment unit 42 allots logical TUs which are, for example, not used at that time to physical TUs to which logical TUs have not been allotted among physical TUs included in a block of interest, and supplies allotment information indicating the result of allotment (for example, pairs of logical TU numbers and physical TU numbers of physical TUs to which logical TUs of the logical TU numbers are allotted, and the like) to the reading and writing control unit 41.

Thus, the reading and writing control unit 41 writes the management information that includes the logical TU numbers paired with the physical TU numbers in the physical TUs of the physical TU numbers included in the allotment information using the allotment information supplied from the allotment unit 42.

Note that, when a writing target physical TU in which the management information is to be written is the last physical TU of a block, all logical TU numbers of logical TUs allotted respectively to physical TUs of the block other than the logical TU number of the logical TU allotted to the writing target physical TU are written in the writing target physical TU as part of the management information.

After the flash memory 16 is formatted, the logical-physical conversion library 22 configured as described above performs a post-formatting process according to, for example, an instruction from the outside.

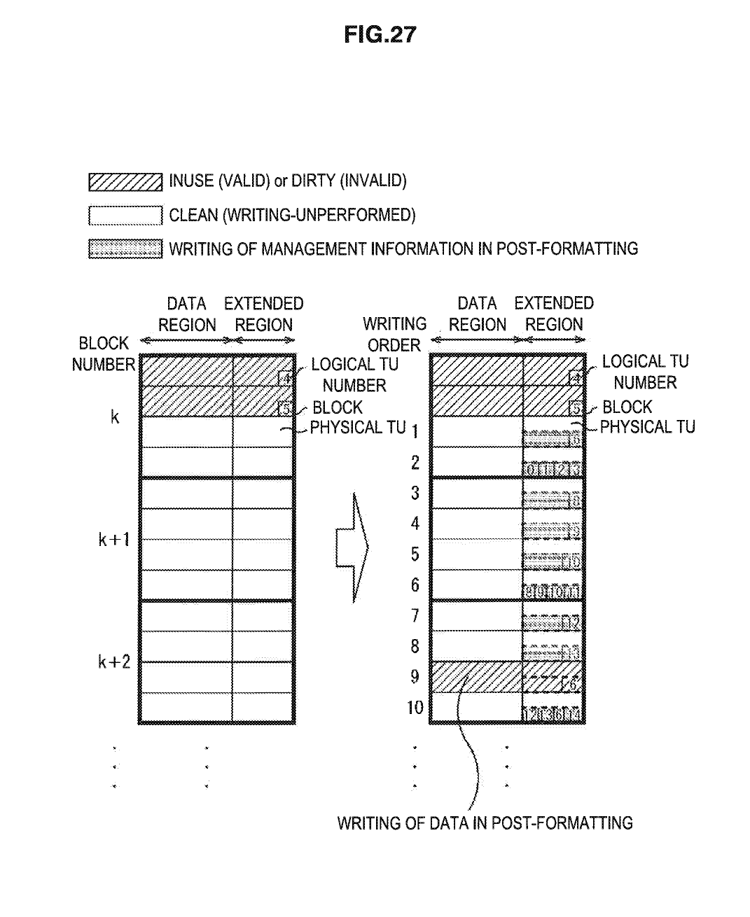

FIG. 27 is a diagram for describing the post-formatting process.

In other words, FIG. 27 illustrates an example of a state of the flash memory 16 in the middle of the steady state and a state of the flash memory 16 after the post-formatting process is performed after the formatting is performed.

After the formatting, the flash memory 16 in the steady state has a number of blocks including writing-unperformed physical TUs as illustrated on the left side of FIG. 27.

In the post-formatting process, blocks including the writing-unperformed physical TUs are sequentially selected as blocks of interest, and among physical TUs included in the blocks of interest, logical TUs are allotted to physical TUs to which the logical TUs are not allotted, in other words, all writing-unperformed physical TUs, and, all logical TU numbers of logical TUs allotted to physical TUs included in each block of interest are written at least in the last physical TU of the block of interest as part of the management information.

As a result, the block of interest turns into a writing-completed block of which all of the physical TUs included in the block of interest are writing-completed physical TUs (hereinafter, also referred to as writing-fully-completed blocks).

The post-formatting process is performed until the number of writing-fully-completed blocks becomes, for example, equal to or greater than the threshold value of the number of blocks M as a predetermined threshold value.

Accordingly, after the post-formatting process, almost all blocks of the flash memory 16, in other words, a number of blocks corresponding to the threshold value of the number of blocks M or more become writing-fully-completed blocks, and the flash memory 16 is put in the steady state. As a result, in reading of management information in the table and map creation process, reading of the management information from the two physical TUs which are the first and the last ones of each block of the flash memory 16 will not be performed for almost all blocks of the flash memory 16 unlike immediately after formatting described in FIG. 17, in other words, the management information from the last physical TU of nearly each block of the flash memory 16 is merely read as described with respect to the steady state of FIG. 17, and therefore, a time required for reading of the management information can be shortened, and further, a flash memory activation time can be shortened.

Note that, in FIG. 27, in the post-formatting process, to the last physical TU of each block, all logical TU numbers of logical TUs each allotted to physical TUs included in the block are written as part of the management information, and to other physical TUs of the block (writing-unperformed physical TUs), the logical TU numbers of the logical TU allotted to each of the physical TUs are written as part of the management information.

However, in the post-formatting process, to the last physical TU of each block, only all of the logical TU numbers of the logical TUs each allotted to the physical TUs included in the block may be written.

In other words, in the present embodiment, although the all-number-writing method is employed, when the all-number-writing method is employed and management information is written in the last physical TU of a block, logical TUs allotted to each of physical TUs of the block can be recognized only by reading the management information from the last physical TU of the block as described in the reading pattern #1 of FIG. 11, and thus it is not necessary to read the management information from the physical TUs other than the last physical TU.

In addition, since it is not necessary to write management information that is not necessary to read, when the all-number-writing method is employed, it is not necessary to write the management information in physical TUs (writing-unperformed physical TUs) other than the last one of a block in the post-formatting process.

In addition, since writing in a data region is not performed only by writing management information in the post-formatting process, data writing can be performed in a shorter period of time than when general data writing is performed.

Further, data can be written on the flash memory 16 even in the middle of the post-formatting process.

In FIG. 27, each block includes four physical TUs, and as the post-formatting process, a process of writing management information including a logical TU number #12 and management information including a logical TU number #13 respectively in a first physical TU and a second physical TU of a block #k+2 is performed, and then data writing for designating a logical TU number #6 to a third physical TU of the block #k+2 is performed.

Then, as the post-formatting process, a process of writing all of logical TU numbers #12, #13, #6, and #14 of logical TUs allotted respectively to the four physical TUs included in the block #k+2 in the last (fourth) physical TU of the block #k+2 is performed.

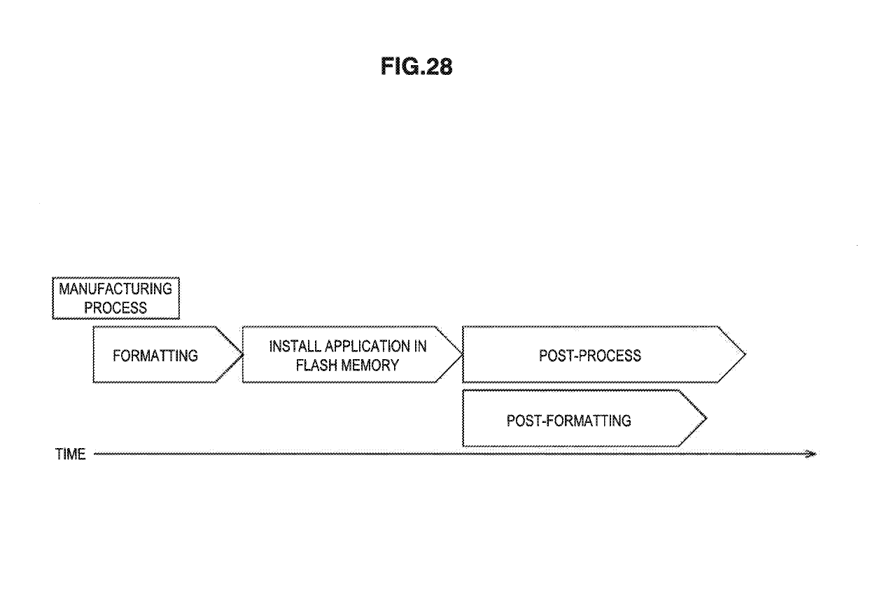

FIG. 28 is a diagram for describing an example of a timing at which the post-formatting process is performed.

The post-formatting process can be performed in parallel with, for example, a post-step of performing operation checking and adjustment of a TV which is performed after the flash memory 16 is formatted and installed data such as applications is installed in the flash memory 16 in the manufacturing step of the TV in a factory as illustrated in FIG. 28.

In this case, the flash memory activation time can be shortened without affecting a takt time.

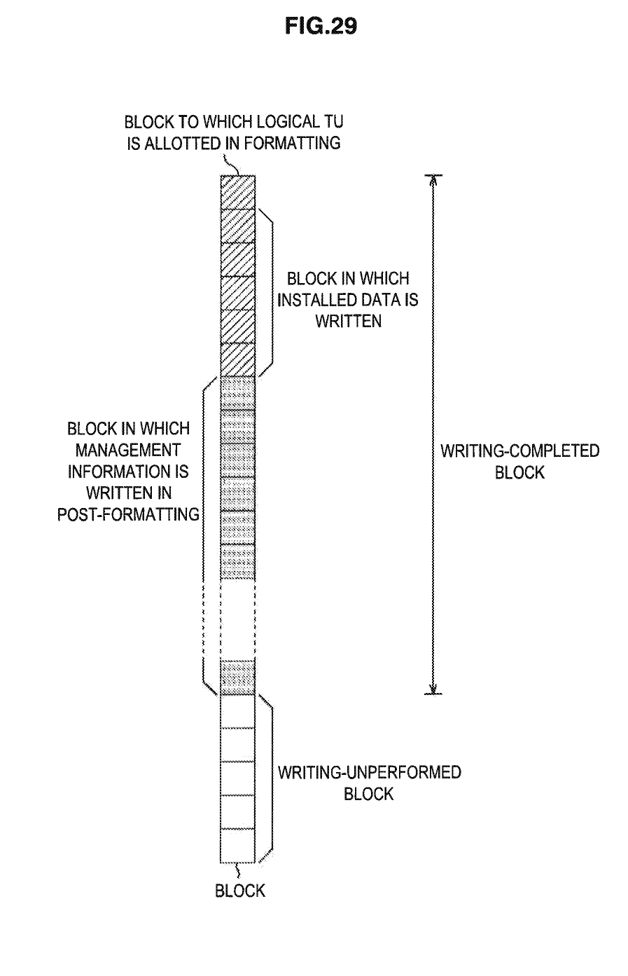

FIG. 29 is a diagram illustrating an example of a state of the flash memory 16 after the post-formatting process when the post-formatting process is performed after installed data is installed in the flash memory 16 as described in FIG. 28.

The post-formatting process can be performed for the flash memory 16 in which the installed data is installed after formatting until the flash memory 16 is in the steady state, in other words, until the number of writing-completed blocks reaches the threshold value of the number of blocks M as illustrated in FIG. 29.

### <Post-Formatting Process>

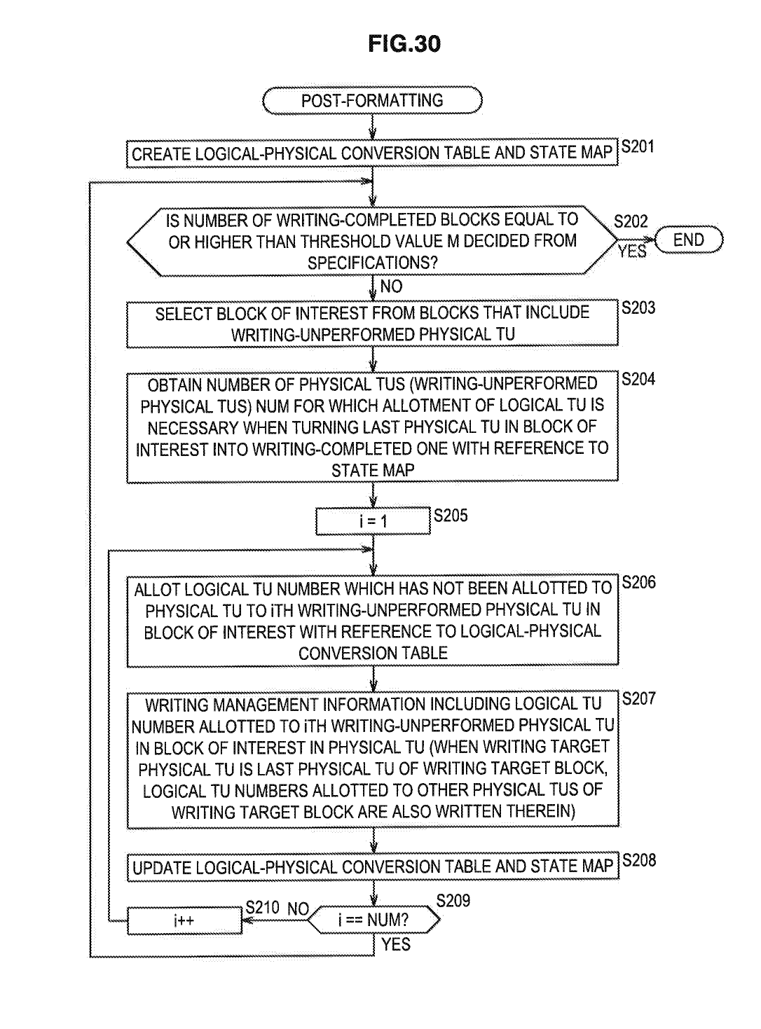

FIG. 30 is a flowchart for describing the post-formatting process performed by the logical-physical conversion library 22 of FIG. 26.

The post-formatting process is started when, for example, there is a request for performing the post-formatting process from an external unit after formatting.

In Step S201 of the post-formatting process, the logical-physical conversion library 22 (of FIG. 26) creates a logical-physical conversion table and a state map by performing, for example, the table and map creation process described in FIG. 9, and stores them in the storage unit 33, and then the process proceeds to Step S202.

In Step S202, the reading and writing control unit 41 (of FIG. 26) determines whether or not the number of writing-fully-completed blocks is equal to or more than the threshold value of the number of blocks M referring to the state map stored in the storage unit 33.

When it is determined that the number of writing-fully-completed blocks is equal to or more than the threshold value of the number of blocks M in Step S202, the process proceeds to Step S203, then the reading and writing control unit 41 selects one of blocks that include writing-unperformed physical TUs as a block of interest referring to the state map stored in the storage unit 33, and then the process proceeds to Step S204.

In Step S204, the allotment unit 42 (of FIG. 26) obtains, for the block of interest, the number of physical TUs for which allotment of logical TUs is needed when the last physical TU of the block of interest becomes writing-completed, in other words, the number of writing-unperformed physical TUs (hereinafter, also referred to as the number of vacant physical TUs) NUM referring to the state map stored in the storage unit 33, and then the process proceeds to Step S205.

In Step S205, the allotment unit 42 initializes a variable i, which is used in counting the number of writing-unperformed physical TUs in the block of interest, to be, for example, 1, and then the process proceeds to Step S206.

In Step S206, the allotment unit 42 allots a logical TU number that has not been allotted to a physical TU to an i^{th} physical TU among the writing-unperformed physical TUs of the block of interest referring to the logical-physical conversion table stored in the storage unit 33, supplies allotment information indicating the result of the allotment to the reading and writing control unit 41, and then the process proceeds to Step S207.

In Step S207, the reading and writing control unit 41 writes management information including the logical TU number included in the allotment information from the allotment unit 42 (logical TU number allotted to the i^{th} physical TU) in the i^{th} physical TU, and then the process proceeds to Step S208.

Note that when the i^{th} physical TU is the last physical TU of a writing target block, all logical TU numbers of logical TUs allotted respectively to other physical TUs of the block of interest in addition to the logical TU number of the logical TU allotted to the last physical TU are included in the management information, and written in the last physical TU.

In addition, only when the i^{th} physical TU is the last physical TU of the writing target block in Step S207, can writing of the management information be performed.

In Step S208, the reading and writing control unit 41 updates the logical-physical conversion table and the state map stored in the storage unit 33 so as to match the state of the flash memory 16 after the management information is written in the i^{th} physical TU in Step S207, and then the process proceeds to Step S209.

In Step S209, the allotment unit 42 determines whether or not the variable i is equal to the number of vacant physical TUs NUM of the block of interest.

When the variable i is determined not to be equal to the number of vacant physical TUs NUM of the block of interest in Step S209, the process proceeds to Step S210, and the allotment unit 42 increases the variable i by ones. Then, the process returns to Step S206 from Step S210 and the same succeeding processes are repeated.

In addition, when the variable i is determined to be equal to the number of vacant physical TUs NUM of the block of interest in Step S209, the process returns to Step S202, and then the same succeeding processes are repeated.

In addition, when it is determined that the number of writing-fully-completed blocks is equal to or more than the threshold value of the number of blocks M in Step S202, in other words, when the flash memory 16 is put in the steady state, the post-formatting process ends.

As described above, after a number of blocks of the flash memory 16 equal to or more than the threshold value of the number of blocks M turn into writing-fully-completed blocks, in other words, when the flash memory 16 is put in the steady state in the post-formatting process, in reading of the management information (of FIG. 12) in Step S11 in the table and map creation process of FIG. 9, reading of the management from the two physical TUs which are the first and the last ones of each block of the flash memory 16 is not performed on almost all of the blocks of the flash memory 16 unlike immediately after the formatting described in FIG. 17, and reading of the management only from the last physical TU of a block is performed for most of the blocks of the flash memory 16 as described with regard to the steady state in FIG. 17, and thus a time required for reading of the management information can be shortened and the flash memory activation time can be shortened.

### An Embodiment of a Memory Card to Which the Present Technology is Applied

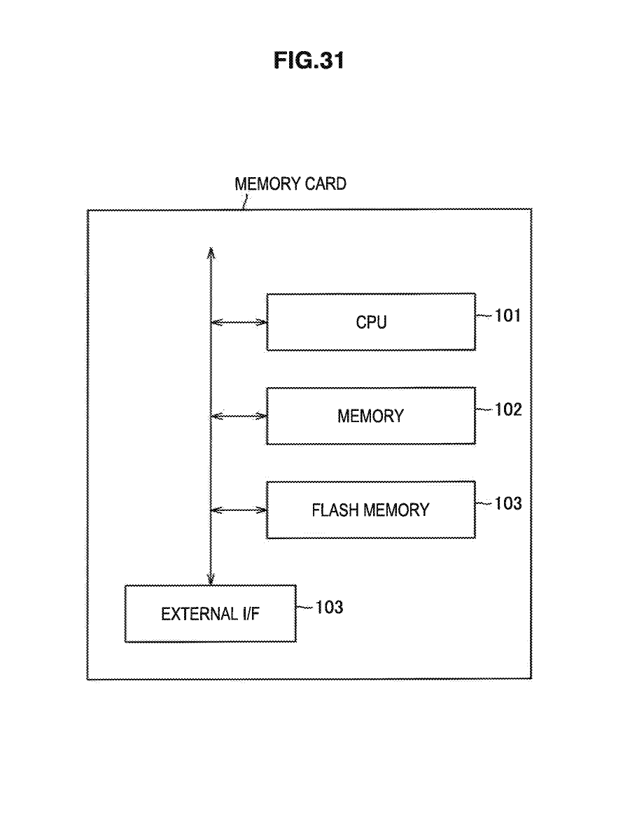

FIG. 31 is a block diagram illustrating a configuration example of hardware of an embodiment of a memory card to which the present technology is applied.

In FIG. 31, the memory card is configured to include a CPU 101, a memory 102, a flash memory 103, and an external I/F (Interface) 104 connected to one another via a bus.

The CPU 101 corresponds to the CPU 12 of FIG. 1, and the memory 102 corresponds to the ROM 13, the RAM 14, and the hard disk 15 of FIG. 1. In addition, the flash memory 103 corresponds to the flash memory 16 of FIG. I.

When the memory card is loaded in a PC, a mobile terminal, a digital camera, or other electronic device, the external I/F 104 is electrically connected to the electronic devices, and exchanges writing target data written in the flash memory 103 or data read from the flash memory 103 with the electrically connected electronic devices.

In the memory card configured as described above, the CPU 101 functions as an access control unit that controls access to the flash memory 103 by executing an OS or other programs installed in the memory 102.

### <Configuration Example of an Access Control Unit>

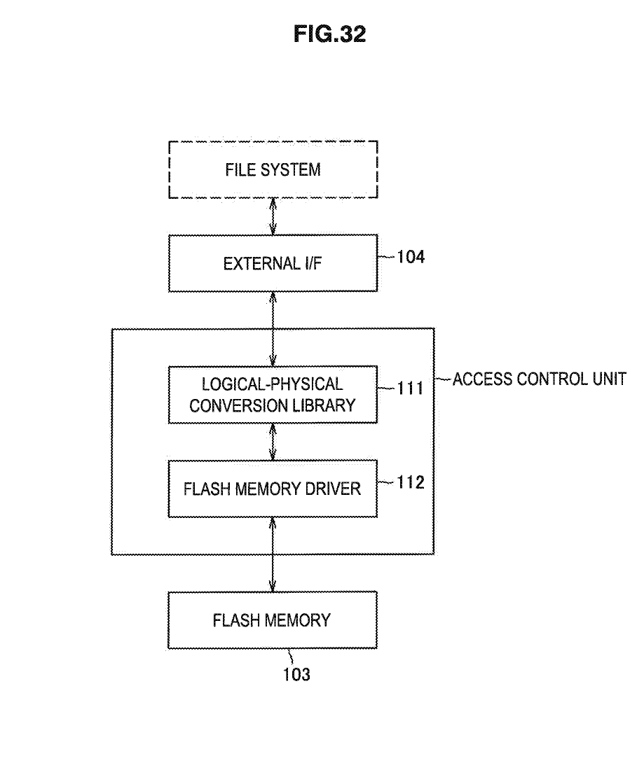

FIG. 32 is a block diagram illustrating a configuration example of an access control unit of which a function is realized by the CPU 101 of FIG. 31 executing a program.

The access control unit is a unit that provides a function of controlling access to the flash memory 103 among functions provided by the CPU 101 of FIG. 31 executing a program, and is configured to include a logical-physical conversion library 111 and a flash memory driver 112 which are software.

In response to a request for reading and writing data to which logical TU numbers are designated made from a file system included in an electronic device that is electrically connected the external I/F 104, the logical-physical conversion library 11 1 converts the logical TU numbers into physical TU numbers, and makes a request for reading and writing data from and on physical TUs having the physical TU numbers to the flash memory driver 112. In addition, the logical-physical conversion library 111 performs the same process as the logical-physical conversion library 22 of FIG. 2.

The flash memory driver 112 performs reading and writing of data from and on the physical TUs of the flash memory 103 in response to the request for reading and writing data from the logical-physical conversion library 111, as the flash memory driver 23 of FIG. 2.

Since the process of the access control unit of FIG. 32 is the same as the process of the access control unit of FIG. 2 except for the process performed in the file system 21, description thereof is omitted.

Here, in the present specification, it is not necessary to perform processes performed by a computer (the CPU 12 or 101) according to programs in a time series manner in an order described as a flowchart. In other words, the processes performed by the computer according to the programs also include processes executed in a parallel or separate manner (for example, parallel processes or processes by objects).

In addition, a program may be processed by one computer (or processor), or may be processed in a distributed manner by a plurality of computers.

Further, in the present specification, a system means a set of a plurality of constituent elements (devices, modules (components), and the like), regardless of whether all of the constituent elements are accommodated in the same housing. Therefore, a plurality of devices which are accommodated in separate housings and connected to one another via a network, and one device configured to accommodate a plurality of modules in one housing are all systems.

Note that an embodiment of the present technology is not limited to that described above, and can be variously modified within the scope not departing from the gist of the present technology. For example, although the case in which the present technology is applied to a TV in which the flash memory 16 is mounted is described in FIG. 1, the present technology is not limited thereto, and can be applied to digital home appliances and various electronic devices in which a flash memory or other non-volatile memory is mounted.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.
(1) A control device including:

a reading and writing control unit configured to control writing and reading of data on and from a non-volatile memory that has a plurality of blocks each set to be a unit for performing erasure of data,

wherein the non-volatile memory stores order information indicating an order of the blocks in which data is to be written, and

wherein the reading and writing control unit selects a writing target block that is a target block for writing of data according to the order indicated by the order information, and writes data in the selected writing target block.
(2) The control device according to (1), wherein the reading and writing control unit writes the order information indicating a predetermined order in the non-volatile memory during formatting of the non-volatile memory, and rewrites the order information so as to indicate a random order when a number of the blocks in which writing of data is completed is equal to or higher than a threshold value decided in advance.
(3) The control device according to (2), further including:

a creation unit configured to create a logical-physical conversion table,

wherein each of the blocks has a plurality of pages each set to be a unit for performing writing and reading of data,

wherein, by setting a unit for performing logical-physical conversion in which a logical memory area is converted into a physical memory area to be a translation unit (TU), the non-volatile memory stores logical TU numbers specifying logical TUs which are logical TUs allotted to physical TUs in the physical TUs each of which is a physical TU and includes one or more of the pages,

wherein a predetermined physical TU among the physical TUs included in the block stores all of the logical TU numbers of the logical TUs each allotted to the physical TUs included in the block, when the logical TUs are allotted to all of the physical TUs included in the block,

wherein the creation unit creates the logical-physical conversion table for converting the logical TUs into the physical TUs based on the logical TU numbers read from the physical TUs, and

wherein, during creation of the logical-physical conversion table, the reading and writing control unit first performs reading of the logical TU numbers from the predetermined physical TU of the block, and performs reading of the logical TU numbers from other physical TUs of the block when the logical TU numbers are not stored in the predetermined physical TU.
(4) The control device according to (3), wherein, when the order information indicates the predetermined order during creation of the logical-physical conversion table, the reading and writing control unit selects a block of interest to be noted from the blocks that the non-volatile memory has in the predetermined order, performs reading of the logical TU numbers from the physical TUs included in the block of interest, and finishes reading of the logical TU numbers in the block of interest when the block of interest has a physical TU in which the logical TU numbers are not stored.
(5) The control device according to (4), wherein, when the order information indicates a random order during creation of the logical-physical conversion table, the reading and writing control unit selects all of the blocks that the non-volatile memory has as blocks of interest in order, and reads logical TU numbers of physical TUs included in the blocks of interest.
(6) The control device according to any one of (3) to (5),

wherein data is written in the physical TUs of the block in numerical order of physical TU numbers specifying the physical TUs, and

wherein the predetermined physical TU is the physical TU in which data is written last.
(7) The control device according to any one of (2) to (6), wherein, during formatting of the non-volatile memory, the reading and writing control unit writes the order information indicating a numerical order of block numbers specifying the blocks, in the non-volatile memory.
(8) The control device according to any one of (2) to (7), wherein, when the number of blocks in which writing of data is completed becomes equal to or higher than the threshold value decided in advance, the reading and writing control unit rewrites the order information so as to indicate a random order by erasing the order information.
(9) The control device according to any one of (1) to (8), further including:

the non-volatile memory.
(10)
A control method performed by a reading and writing control unit of a control device including the reading and writing control unit configured to control reading and writing of data on and from a non-volatile memory that has a plurality of blocks each set to be a unit for performing erasure of data, the non-volatile memory storing order information indicating an order of the blocks in which data is to be written, the method including:

selecting a writing target block that is a target block for writing of data according to the order indicated by the order information and writing data.

selecting a writing target block that is a target block for writing of data according to the order indicated by the order information and writing data by the reading and writing control unit.
(11) A program for causing a computer to function as a reading and writing control unit configured to control reading and writing of data on and from a non-volatile memory that has a plurality of blocks each set to be a unit for performing erasure of data,

wherein the non-volatile memory stores order information indicating an order of the blocks in which data is to be written, and

wherein the reading and writing control unit selects a writing target block that is a target block for writing of data according to the order indicated by the order information and writes data.
(12) A control device including:

a reading and writing control unit configured to control writing and reading of data on and from a non-volatile memory that has a plurality of blocks each set to be a unit for performing erasure of data; and

an allotment unit configured to allot a logical Translation Unit (TU) to a physical TU,

wherein each of the blocks has a plurality of pages each set to be a unit for performing writing and reading of data,

wherein, by setting a unit for performing logical-physical conversion in which a logical memory area is converted into a physical memory area to be a TU, the non-volatile memory stores logical TU numbers specifying logical TUs which are logical TUs allotted to physical TUs, in the physical TUs which are physical TUs each of which includes one or more of the pages,

wherein a predetermined physical TU among the physical TUs included in the block stores all of the logical TU numbers of the logical TUs each allotted to the physical TUs included in the block when the logical TUs are allotted to all of the physical TUs included in the block, and

wherein, when the number of blocks in which writing of data is completed is not equal to or higher than a threshold value decided in advance, the allotment unit allots the logical TUs to all physical TUs to which the logical TUs are not allotted, among physical TUs included in a block of interest to be noted selected from the blocks that include writing-unperformed physical TUs, and the reading and writing control unit writes all of the logical TU numbers of the logical TUs each allotted to the physical TUs included in the block of interest, in the predetermined physical TU included in the block of interest.
(13) The control device according to (12), wherein the reading and writing control unit further writes, to the physical TUs other than the predetermined physical TU included in the block of interest, the logical TU numbers of the logical TUs allotted to the physical TUs.
(14) The control device according to any one of (12) or (13), further including:

a creation unit configured to create a logical-physical conversion table for converting the logical TUs into the physical TUs based on the logical TU numbers read from the physical TUs,

wherein, during creation of the logical-physical conversion table, the reading and writing control unit first performs reading of the logical TU numbers from the predetermined physical TU of the block, and performs reading of the logical TU numbers from the other physical TUs of the block when the logical TU numbers are not stored in the predetermined physical TU.
(15) The control device according to any one of (12) to (14),

wherein data is written in a numeral order of physical TU numbers specifying the physical TUs, in the physical TUs included in the block, and

wherein the predetermined physical TU is a physical TU in which data is written last.
(16) The control device according to any one of (12) to (15), further including:

the non-volatile memory.

1. A control device comprising:
a reading and writing control unit configured to control writing and reading of data on and from a non-volatile memory that has a plurality of blocks each set to be a unit for performing erasure of data,
wherein the non-volatile memory stores order information indicating an order of the blocks in which data is to be written, and
wherein the reading and writing control unit selects a writing target block that is a target block for writing of data according to the order indicated by the order information, and writes data in the selected writing target block.

2. The control device according to claim 1, wherein the reading and writing control unit writes the order information indicating a predetermined order in the non-volatile memory during formatting of the non-volatile memory, and rewrites the order information so as to indicate a random order when a number of the blocks in which writing of data is completed is equal to or higher than a threshold value decided in advance.

3. The control device according to claim 2, further comprising:
a creation unit configured to create a logical-physical translation table,
wherein each of the blocks has a plurality of pages each set to be a unit for performing writing and reading of data,
wherein, by setting a unit for performing logical-physical conversion in which a logical memory area is translated into a physical memory area to be a translation unit (TU), the non-volatile memory stores logical TU numbers specifying logical TUs which are logical TUs allotted to physical TUs in the physical TUs each of which is a physical TU and includes one or more of the pages,
wherein a predetermined physical TU among the physical TUs included in the block stores all of the logical TU numbers of the logical TUs each allotted to the physical TUs included in the block, when the logical TUs are allotted to all of the physical TUs included in the block,
wherein the creation unit creates the logical-physical conversion table for converting the logical TUs into the physical TUs based on the logical TU numbers read from the physical TUs, and
wherein, during creation of the logical-physical conversion table, the reading and writing control unit first performs reading of the logical TU numbers from the predetermined physical TU of the block, and performs reading of the logical TU numbers from other physical TUs of the block when the logical TU numbers are not stored in the predetermined physical TU.

4. The control device according to claim 3, wherein, when the order information indicates the predetermined order during creation of the logical-physical conversion table, the reading and writing control unit selects a block of interest to be noted from the blocks that the non-volatile memory has in the predetermined order, performs reading of the logical TU numbers from the physical TUs included in the block of interest, and finishes reading of the logical TU numbers in the block of interest when the block of interest has a physical TU in which the logical TU numbers are not stored.

5. The control device according to claim 4, wherein, when the order information indicates a random order during creation of the logical-physical conversion table, the reading and writing control unit selects all of the blocks that the non-volatile memory has as blocks of interest in order, and reads logical TU numbers of physical TUs included in the blocks of interest.

6. The control device according to claim 4,
wherein data is written in the physical TUs of the block in numerical order of physical TU numbers specifying the physical TUs, and
wherein the predetermined physical TU is the physical TU in which data is written last.

7. The control device according to claim 4, wherein, during formatting of the non-volatile memory, the reading and writing control unit writes the order information indicating a numerical order of block numbers specifying the blocks, in the non-volatile memory.

8. The control device according to claim 4, wherein, when the number of blocks in which writing of data is completed becomes equal to or higher than the threshold value decided in advance, the reading and writing control unit rewrites the order information so as to indicate a random order by erasing the order information.

9. The control device according to claim 4, further comprising:
the non-volatile memory.

10. A control method performed by a reading and writing control unit of a control device including the reading and writing control unit configured to control reading and writing of data on and from a non-volatile memory that has a plurality of blocks each set to be a unit for performing erasure of data, the non-volatile memory storing order information indicating an order of the blocks in which data is to be written, the method comprising:
selecting a writing target block that is a target block for writing of data according to the order indicated by the order information and writing data.

11. A program for causing a computer to function as a reading and writing control unit configured to control reading and writing of data on and from a non-volatile memory that has a plurality of blocks each set to be a unit for performing erasure of data,
wherein the non-volatile memory stores order information indicating an order of the blocks in which data is to be written, and
wherein the reading and writing control unit selects a writing target block that is a target block for writing of data according to the order indicated by the order information and writes data.

12. A control device comprising:
a reading and writing control unit configured to control writing and reading of data on and from a non-volatile memory that has a plurality of blocks each set to be a unit for performing erasure of data; and
an allotment unit configured to allot a logical Translation Unit (TU) to a physical TU,
wherein each of the blocks has a plurality of pages each set to be a unit for performing writing and reading of data,
wherein, by setting a unit for performing logical-physical conversion in which a logical memory area is converted into a physical memory area to be a TU, the non-volatile memory stores logical TU numbers specifying logical TUs which are logical TUs allotted to physical TUs, in the physical TUs which are physical TUs each of which includes one or more of the pages,
wherein a predetermined physical TU among the physical TUs included in the block stores all of the logical TU numbers of the logical TUs each allotted to the physical TUs included in the block when the logical TUs are allotted to all of the physical TUs included in the block, and
wherein, when the number of blocks in which writing of data is completed is not equal to or higher than a threshold value decided in advance, the allotment unit allots the logical TUs to all physical TUs to which the logical TUs are not allotted, among physical TUs included in a block of interest to be noted selected from the blocks that include writing-unperformed physical TUs, and the reading and writing control unit writes all of the logical TU numbers of the logical TUs each allotted to the physical TUs included in the block of interest, in the predetermined physical TU included in the block of interest.

13. The control device according to claim 12, wherein the reading and writing control unit further writes, to the physical TUs other than the predetermined physical TU included in the block of interest, the logical TU numbers of the logical TUs allotted to the physical TUs.

14. The control device according to claim 13, further comprising:
a creation unit configured to create a logical-physical conversion table for converting the logical TUs into the physical TUs based on the logical TU numbers read from the physical TUs,
wherein, during creation of the logical-physical conversion table, the reading and writing control unit first performs reading of the logical TU numbers from the predetermined physical TU of the block, and performs reading of the logical TU numbers from the other physical TUs of the block when the logical TU numbers are not stored in the predetermined physical TU.

15. The control device according to claim 14,
wherein data is written in a numeral order of physical TU numbers specifying the physical TUs, in the physical TUs included in the block, and
wherein the predetermined physical TU is a physical TU in which data is written last.

16. The control device according to claim 14, further comprising:
the non-volatile memory.
